(19) United States
(12) Patent Application Publication
(10) Pub. No.: US 2023/0363431 A1
(43) Pub. Date: Nov. 16, 2023

(54) Aroma Composition Having a Grill-Type Flavour Profile

(71) Applicant: Symrise AG, Holzminden (DE)

(72) Inventors: Sebastian Heine, Höxter (DE); Jens Koch, Eschershausen (DE)

(21) Appl. No.: 18/247,026

(22) PCT Filed: Oct. 1, 2020
(86) PCT No.: PCT/EP2020/077596

§ 371 Date: Mar. 28, 2023

(51) Int. Cl. A23L 27/27; A23L 27/00

(52) U.S. Cl. CPC A23L 27/27; A23L 27/70

(57) ABSTRACT

The present invention relates to a method for preparing an aroma composition having a grill-type flavour profile. The present invention also relates to an aroma composition obtainable using said method and to the use of said aroma composition for providing or enhancing a grill-type flavour and for preparing a foodstuff, food supplement or animal feed. The present invention also relates to food or animal feed products as such which comprise the aroma composition having a grill-type flavour profile. Finally, the present invention relates to an apparatus for preparing said aroma composition.

### TECHNICAL FIELD

The present invention relates to a method for preparing an aroma composition having a grill-type flavour profile. The present invention also relates to an aroma composition obtainable by said method and to the use of said aroma composition for providing or enhancing a grill-type flavour and for preparing a foodstuff, food supplement or animal feed. The present invention also relates to foodstuff, food supplement or animal feed products as such which comprise the aroma composition having a grill-type flavour profile. Finally, the present invention relates to an apparatus for preparing said aroma composition.

### BACKGROUND ART

Flavours of various types are widely used in the food processing industry. In savoury food products, aroma compositions having a grill-type flavour profile are widely used to impart a grill note or barbeque note flavour to food products for taste purposes.

Grill flavours that mimic or evoke grilled foods are popular in the food industry for inclusion in a wide range of products and are referred to generally as “grill flavour” or “grill-type flavour”. The aroma compositions having a grill-type flavour profile are adapted to mimic the flavours normally created by grilling meat products, which are made of meat protein, meat carbohydrates and animal fat, when typically exposed to temperatures by so-called Maillard reactions. Maillard reactions can produce hundreds of different flavour compounds depending on the chemical constituents in the food, the temperature, the cooking time and the presence of air. These compounds often in turn break down to form yet more new flavour compounds.

Grill-type flavours serve to impart a highly flavoured grill note to prepared foods without requiring actual grilling of the food. Grill flavours also facilitate the inner incorporation of a grill flavour in numerous foods which cannot otherwise be grilled and therefore serve to facilitate grill flavours without burning or carbonisation.

Typical grilled flavours include those used for the preparation of products in which the meat content is reduced or non-existent, for example in sauces, snack foods, meat substitutes, pet foods and the like. Such flavouring compositions can be sprayed onto the foodstuff, or foods can be dipped in a solution of the flavouring, or the flavouring can be applied in a variety of other manners.

Grill-type flavours and methods for producing the same which are obtained by pyrolysis reactions are known from the prior art.

GB 2 363 967 (Colm Declan Menton) describes a process for the preparation of a grill flavour comprising the steps of thermally treating a sunflower oil, to prepare a flavour concentrate, and mixing the flavour concentrate with a sunflower oil.

A known grill flavouring described in EP 0 867 122 A1 (Ensyn Technologies Inc.) is obtained by heating a spray or atomised droplets of a saturated or partially saturated vegetable oil to a temperature of at least 480° C. in an oxygen-starved atmosphere in a fast pyrolysis reactor.

WO 2019/141357 A1 (Symrise AG) discloses a flavouring substance composition having barbecue-type aroma profiles containing (a) at least five linear or branched, saturated aliphatic C5-to-C16 monocarboxylic acids and (b) at least two α,β-unsaturated C10 aldehydes, and a method for their production. In the method for preparing the flavouring, a vegetable or animal oil or fat or mixtures thereof is/are heated to a temperature of 80° C. to 300° C. at a pressure of 0 to 5 bars for 0.1 to 6 seconds, the resulting product is cooled, and the liquid flavour composition obtained is collected.

A common characteristic feature of most of the methods described in the prior art is that pyrolysis or thermolysis is performed either in an inert atmosphere or in the presence of oxygen or air, for example by purging air.

However, the products obtained using such methods generally have a limited aroma profile and a limited level of flavour concentration. In particular, the methods described in the prior art are characterised by the fact that the aroma or flavour composition is prepared at high temperatures, usually at least 350° C., and in the presence of oxygen. Under such drastic conditions, the flavouring oils or fats undergo severe physicochemical changes, such as oxidation of double bonds in fatty acids, or condensation of glycerol with fatty acid decomposition fragments, to name but a few. Thus, the resulting oils and fats have a dark, yellowish-brown to dark brown colour and an aroma and taste resembling that of exhausted deep-frying oils. These aromas and tastes are undesirable, since on the one hand they impart an aroma composition with petrol, tarry or tart notes and on the other hand pose a health hazard. Deep-frying fats have been identified as a source of toxic products such as for example polycyclic aromatic hydrocarbons which may be formed during pyrolysis or the combustion of fats at temperatures above 400° C. For this reason, prior-art methods require additional and complex purification steps to separate or eliminate these undesirable substances.

There is therefore an ongoing need to provide a new production process for an aroma composition having a grill-type aroma profile. Another aim of the present invention is to provide new aroma composition products that mimic or evoke grill-type flavours. There is also a strong need to provide a new aroma composition having an improved grill-type flavour profile. Yet another aim is to ameliorate and/or overcome deficiencies identified in known grill flavourings. Finally, one more aim is to provide products with an improved grill-type flavour profile.

The primary object of the present invention is thus to provide a method for producing an aroma composition which exhibits a novel, intensified, harmonious and well-balanced grill-type flavour profile and which prevents or reduces the formation of undesirable flavour compounds such as undecane, heptane, 2E-octene, 1-nonene, cyclooctene, and nonadecane, etc.

Another object of the present invention is thus to provide an aroma composition which exhibits a novel, intensified, harmonious and well-balanced grill-type flavour profile. In particular, the aroma composition should generate and/or enhance a fatty/oily and/or smoky and/or roasted and/or burnt and/or animalic flavour and at the same time suppress and/or reduce a waxy flavour.

Another aim of the present invention is to provide an apparatus for preparing the aroma composition having a grill-type flavour profile of the present invention.

It has been unexpectedly observed that a method in which vegetable or animal oil or fat or mixtures thereof is/are heated to a temperature of 310° C. to 400° C. at a pressure of 2 to 5 bars in the absence of air or oxygen in the reaction zone, i.e. without air or oxygen supply, and the heated oil stream is subsequently atomised through a nozzle, results in a new and improved aroma composition having a uniquely distinct grill-type flavour profile. The grill-type flavour profile is dominated by grill-type flavour notes characterised by extremely fatty/oily and/or smoky and/or roasted and/or burnt and/or animalic flavour notes and reduced amounts of waxy flavour notes which are distinctive from the flavour notes or characteristics of aroma compositions achieved using the methods according to the prior art, even when using the same feedstock.

According to the present invention, “flavour note” means a compound or compounds that gives rise to a flavour component of the aroma composition according to the present invention.

The distinctive differences in flavour and enhanced, i.e. higher, concentrations of said grill-type flavour notes indicate that a new and different composition results from the present method. Such an unique grill-type flavouring is highly desirable for use in the food-flavouring industry, since a reduced amount of flavouring (additive) can then be used to achieve the desired flavouring. In addition, more pronounced flavouring can be achieved by using equivalent amounts, as compared to other grill-type flavourings.

It has also surprisingly been found that the method according to the present invention prevents or reduces the formation of undesirable flavour compounds such as undecane, heptane, 2E-octene, 1-nonene, cyclooctene, and nonadecane, etc., which are harmful to the sensory properties of the aroma composition, such that the aroma composition manufactured can be directly used without preceding additional purification steps.

### SUMMARY OF THE INVENTION

In a first aspect, the present invention relates to a method for preparing an aroma composition having a grill-type flavour profile, comprising or consisting of the following sequence of steps:
(a) providing a vegetable or animal oil or fat or a mixture thereof;
(b) transferring the product of step (a) to a reactor and heating the product to a temperature in the range of 310° C. to 400° C., in particular 350° C. to 380° C., and a pressure in the range of 2 to 6 bars, to obtain an oil stream;
(c) atomising the oil stream, thereby fragmenting the oil stream into a liquid oil phase and an aerosol comprising an aroma composition having a grill-type flavour profile, by an atomising device, preferably by a nozzle;
(d) transferring the aerosol containing the aroma to a second line and transferring the liquid oil phase to a third line;
(e) discharging the aerosol containing the aroma by collecting the aerosol or absorbing the aerosol on a solid carrier or in a liquid carrier; and
(f) optionally returning the liquid oil phase from step (d) to the reactor.

In a second aspect, the present invention relates to an aroma composition having a grill-type flavour profile obtainable using the method according to the present invention.

In a third aspect, the present invention relates to the use of the aroma composition having a grill-type flavour composition for providing or enhancing a fatty/oily and/or smoky and/or roasted and/or burnt and/or animalic flavour and for simultaneously suppressing and/or reducing a waxy flavour in a foodstuff, food supplement or animal feed and/or for preparing a foodstuff, food supplement or animal feed.

In a fourth aspect, the present invention relates to consumer products, food supplements or animal feed to which the aroma composition according to the present invention has been applied.

Finally, the present invention relates to an apparatus for producing an aroma composition having a grill-type flavour profile, with a reactor 1 comprising:
(i) a reservoir 2 for the vegetable or animal oil or fat or a mixture thereof, a pump 3, and a heater 4 adapted to heat the vegetable or animal oil or fat or mixture thereof to generate a heated oil stream;
(ii) an atomizing device, preferably a nozzle 6, adapted to atomise the heated oil stream in order to fragment the oil stream into a liquid oil phase and an aerosol comprising the aroma composition having a grill-type flavour profile;
(iii) optionally an inlet 7 adapted to inject a fluid or gas adjacent to the nozzle exit or to apply a vacuum adjacent to the nozzle exit;
(iv) a second line 9 adapted to discharge the aerosol containing the grill-type flavour;
(v) a third line 10 adapted to return the liquid oil phase to the reactor;
(vi) a container 11 adapted to collect the aerosol; and
(vii) a collection vessel 12 adapted to collect the liquid oil phase.

### DESCRIPTION OF THE FIGURES

FIG. 1 is a schematic view of the apparatus according to the present invention.

FIGS. 2a and 2b are each a schematic cross-section of a preferred embodiment of a nozzle of the apparatus according to the present invention, describing single component type nozzles without additive gases and the like—an straight-forward orifice.

FIG. 3 is a schematic cross-section of another preferred embodiment of a nozzle of the apparatus according to the present invention, using an additive, usually an inert atomiser gas.

FIG. 4 is a schematic cross-section of another preferred embodiment of a nozzle of the apparatus according to the present invention, which is an internal mix nozzle, where the atomiser gas is supplied in the interior of the nozzle.

FIG. 5 is a schematic cross-section of another preferred embodiment of a nozzle of the apparatus according to the present invention, which describes effervescent atomisation, which is a special type of atomisation.

FIG. 6 is a schematic cross-section of a preferred embodiment of a Venturi nozzle of the apparatus according to the present invention.

FIG. 7 is a schematic cross-section of another preferred embodiment of a nozzle of the apparatus according to the present invention.

FIG. 8 is a spider diagram showing the flavour profile of the grill-type flavour according to the present invention in comparison with the flavour profile of a grill-type flavour according to the prior art. The comparison is shown for the flavour profile of the grill-type flavour obtained according to WO 2019/141357 A1 and a flavour profile obtained according to the present invention after 4 intakes.

The invention is specified in the appended claims. The invention itself, and its preferred variants, other objects and advantages, are however also apparent from the following detailed description in conjunction with the accompanying examples and figures.

### DETAILED DESCRIPTION OF THE INVENTION

The present invention will now be described by referring to the accompanying figures. In the following description, corresponding elements as shown in each figure of the drawings are given the same reference sign.

In a first aspect, the present invention relates to a method for preparing an aroma composition having a grill-type flavour profile, comprising or consisting of the following sequence of steps:
(a) providing a vegetable or animal oil or fat or a mixture thereof;
(b) transferring the product of step (a) to a reactor and heating the product to a temperature in the range of 310° C. to 400° C., in particular 350° C. to 380° C., and a pressure in the range of 2 to 6 bars, to obtain an oil stream;
(c) atomising the oil stream, thereby fragmenting the oil stream into a liquid oil phase and an aerosol comprising an aroma composition having a grill-type flavour profile, by an atomizing device, preferably by a nozzle;
(d) transferring the aerosol containing the aroma to a second line and transferring the liquid oil phase to a third line;
(e) discharging the aerosol containing the aroma by collecting the aerosol or absorbing the aerosol on a solid carrier or in a liquid carrier; and
(f) optionally returning the liquid oil phase from step (d) to the reactor.

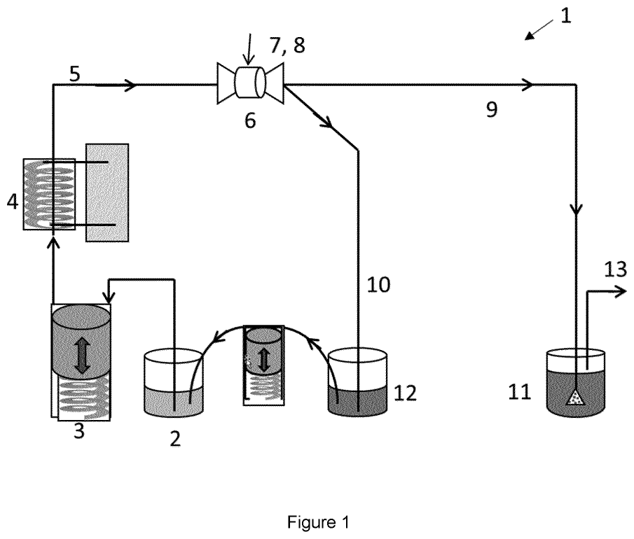

FIG. 1 depicts a schematic view of the apparatus according to the present invention. The apparatus comprises a reactor 1 of the type that can be utilised to make an aroma composition having a grill-type flavour profile. The reactor 1 comprises a reservoir 2 in which a vegetable or animal oil or a fat or a mixture thereof is provided, a pump 3 and a heater 4. The reactor 1 also comprises a first line 5, an atomizing device which is preferably a nozzle 6, a second line 9, a third line 10, a container 11 for the aroma discharged and finally a collection vessel 12 for the liquid oil phase.

One of the features of the process according to the invention is that the aroma composition can be produced in a continuous reactor, which enables the flavour composition to be produced continuously. The composition can, however, alternatively be produced in batches.

In a first step (a) of the method according to the present invention, a vegetable or animal oil or vegetable or animal fat or a mixture thereof is provided as a starting product for producing the aroma composition according to the present invention. For the purposes of the present application, this means that a single vegetable oil or a single animal oil or a single vegetable fat or a single animal fat or a mixture of two or more of a vegetable oil, animal oil, vegetable fat or animal fat may be used.

Vegetable oils and fats are biological mixtures of plant origin consisting of ester mixtures derived from glycerol with chain of fatty acids. Both, the physical and the chemical characteristics of oils and fats are greatly influenced by the kind and proportion of the fatty acids on the triacylglycerol. Fatty acids can be classified in classes of saturated, mono-unsaturated (MUFA) and poly-unsaturated (PUFA) fatty acids. The predominant fatty acids present in vegetable oils and fats are saturated and unsaturated compounds with straight aliphatic chains. An even number of carbon atoms, from 16 to 18 with a single carboxyl group, is the most common. A number of minor fatty acids may be present in same vegetable sources, including a small amount of branched chain, cyclic and odd number straight chain acids. An important feature common to most plant origin oils and fats is the high percentage of unsaturated fatty acids in the triacylglycerols. In general, the higher degree of unsaturation of fatty acids in vegetable oils is, the more susceptible they are to oxidative deterioration. Therefore, it is essential to know the composition of fatty acids of an oil or fat, to identify their characteristics and to know the physical and the chemical properties. The fatty acid composition of safflower and sunflower oil contains a healthy mixture of all the types of saturated and unsaturated fatty acid. The value of P/S index which is associated to the impact in the human health is also high for safflower and sunflower oil.

The appropriate vegetable oils that are utilized in the method according to the present invention are those having a high stability, namely, those vegetable oils, that are saturated or are partially unsaturated.

Examples of appropriate vegetable oils used in the method according to the present invention include unsaturated, saturated or partially saturated palm oil, palm kernel oil, soybean oil, sunflower oil, peanut oil, olive oil, rapeseed oil, grapeseed oil, canola oil, corn oil, coconut oil, sesame oil, poppyseed oil, safflower oil, pumpkin seed oil, rice bran oil, almond oil, pecan oil, macadamia oil, cottonseed oil, linseed oil, or mixtures of two or more of these vegetable oils. Alternative feedstocks include animal fats such as pig fat (lard), beef fat (tallow), mutton fat (tallow), bacon dripping, chicken fat, turkey fat, butter or mixtures of two or more of these animal fats.

According to Vesna Kostik et al., Fatty acid composition of edible oils and fats, HEDJ Journal of Hygienic Engineering and Design, original scientific paper, UDC 664.3:577.115.3, the content of the following saturated and unsaturated fatty acids caproic acid (C6:0), caprylic acid (C8:0), capric acid (C10:0), lauric acid (C12:0), myristic acid (C14:0), palmitic acid (C16:0), stearic acid (C18:0), arachidic acid (C20:0), behenic acid (C22:0), lignoceric acid (C24:0) oleic acid (C18:1), linoleic acid (C18:2) and linolenic acid (C18:3) of the following tested oil samples is as shown in Table 1 and Table 2. respectively:

TABLE 1
Saturated fatty acid (SFA) composition of different vegetable oils and fats (% w/w)

| | Mean ± SD | | | | | | | |
|---|---|---|---|---|---|---|---|---|
| Type of | C6:0 | C8:8 | C10:0 | C12:0 | C14:0 | C16:0 | C18:0 | C20:0 |
| oil/fat | (%) | (%) | (%) | (%) | (%) | (%) | (%) | (%) |
| Coconut | 0.04 ± 0.2 | 7 ± 2.0 | 8 ± 2.0 | 48 ± 4 | 16 ± 3 | 9.2 ± 1.5 | 2 ± 1.0 | 0.25 ± 0.2 |
| Corn | — | 4 ± 0.8 | 7 ± 1.2 | — | 0.6 ± 0.4 | 10 ± 2 | 3.5 ± 1.5 | — |
| Cottonseed | — | — | — | — | 0.4 ± 0.2 | 20 ± 2.5 | 2 ± 0.6 | — |
| Linseed | — | — | — | — | — | 5.5 ± 1.5 | 3.5 ± 1.2 | 0.65 ± 0.3 |
| Palm | — | 4 ± 1 | 5 ± 2 | 41 ± 5 | 16 ± 2 | 8 ± 0.0 | 2 ± 0.8 | — |
| kernel | | | | | | | | |
| Olive | — | — | — | — | 0.65 ± 0.2 | 11.5 ± 4 | 2 ± 0.5 | 0.22 ± 0.12 |
| Soybean | — | — | — | — | 0.5 ± 0.2 | 9 ± 2 | 4 ± 1 | — |
| Sunflower | — | — | — | — | — | 3.7 ± 1.5 | 2 ± 0.8 | 2.3 ± 1.2 |
| Peanut | — | — | — | — | — | 7.5 ± 1.5 | 4.5 ± 1.8 | 3 ± 1.2 |
| Safflower | — | — | — | — | 0.5 ± 0.2 | 4.0 ± 1.8 | 2.5 ± 0.1 | 0.2 ± 0.1 |
| Canola | — | — | — | — | — | 5.2 ± 0.6 | 4.4 ± 1.4 | — |
| Type 1 | | | | | | | | |
| Canola | — | — | — | — | — | 10.5 ± 2.5 | 6.9 ± 1.6 | — |
| Type 2 | | | | | | | | |

TABLE 2
Unsaturated fatty acid (UFA) composition of
different vegetable oils and fats (% w/w)

Mean ± SD

| Type of oil/fat | C18:1 (%) | C18:2 (%) | C18:3 (%) |
|---|---|---|---|
| Coconut | 8.8 ± 0.85 | 0.5 ± 0.2 | — |
| Corn | 26.8 ± 1.2 | 48 ± 4.5 | — |
| Cottonseed | 35.4 ± 2.4 | 42 ± 4.8 | — |
| Linseed | 22.1 ± 1.5 | 20.5 ± 1.5 | 47.5 ± 5.6 |
| Palm kernel | 22.5 ± 2.2 | 1.25 ± 0.55 | — |
| Olive | 78.4 ± 4.3 | 7.0 ± 3.3 | — |
| Soybean | 28.5 ± 1.2 | 49.5 ± 6.5 | 8 ± 3.4 |
| Sunflower | 31.5 ± 4.5 | 59.5 ± 7.5 | — |
| Peanut | 58.5 ± 5.8 | 20 ± 2.7 | — |
| Safflower | 16.6 ± 4.5 | 76 ± 3 | — |
| Canola Type 1 | 59.5 ± 1.907 | 18.8 ± 3.5 | 11.9 ± 1.1 |
| Canola Type 2 | 23.2 ± 2.9 | 15.2 ± 3.6 | 44 ± 2.02 |

The content of total saturated fatty acid (SFA), monounsaturated fatty acid (MFA), polyunsaturated fatty acids (PUFA) and the relationship between saturated and poly-unsaturated fatty acid content is expressed as P/S index. The P/S index is an important parameter for determination of nutritional value of certain oil. Oils and fats with a higher P/S index value that 1 are considered to have nutritional value. The highest P/S index value was found for safflower oil.

TABLE 3
The content of saturated fatty acids (SFA),
monounsaturated fatty acids (MUFA), polyunsaturated
fatty acids (PUFA (% w/w) and the values of P/S
indexes (poly-unsaturated/saturated index)
of different types of vegetable oils

| Type of | Mean ± SD | | | P/S |
|---|---|---|---|---|
| oil/fat | SFA (%) | MUFA (%) | PUFA (%) | index |
| Coconut | 90.5 ± 2.95 | 8.8 ± 0.85 | 0.5 ± 0.02 | 0.005 |
| Corn | 25.1 ± 1.8 | 26.8 ± 1.2 | 48 ± 4.5 | 1.91 |
| Cottonseed | 22.4 ± 1.22 | 35.4 ± 2.4 | 42 ± 4.8 | 1.87 |
| Linseed | 9.65 ± 1.05 | 22.1 ± 1.5 | 68 ± 2.9 | 7.05 |
| Palm | 76 ± 1.95 | 22.5 ± 2.2 | 1.25 ± 0.55 | 0.016 |
| kernel | | | | |
| Olive | 14.35 ± 1.9 | 78.4 ± 4.3 | 7.0 ± 0.33 | 0.49 |
| Soybean | 13.5 ± 0.93 | 28.5 ± 1.2 | 57.5 ± 2.2 | 4.26 |
| Sunflower | 8.8 ± 0.8 | 31.5 ± 4.5 | 59.5 ± 7.5 | 6.76 |
| Peanut | 19.2 ± 0.37 | 58.5 ± 5.8 | 20 ± 2.7 | 1.04 |
| Safflower | 7.2 ± 0.3 | 16.6 ± 4.5 | 76 ± 3 | 10.55 |
| Canola | 9.6 ± 0.56 | 59.5 ± 1.907 | 30.7 ± 1.7 | 3.2 |
| Type 1 | | | | |
| Canola | 17.4 ± 0.67 | 23.2 ± 2.9 | 59.2 ± 1.1 | 3.4 |
| Type 2 | | | | |

Sunflower oil seed oil showed high PUFA content (59.5%±7.5) with the predominant presence of linoleic acid (C18:2). The highest content of total unsaturated fatty acids was found for safflower (92.6%±1.0) and sunflower oil (91%±2.12).

The above fatty acid contents and results are in line with the data obtained from the literature (see Zambiazi R. C. et al., Fatty acid composition of vegetable oils and fats (2007), B.CEPPA, Curitiba (25(1), pages 111-120 and Daniewski M., et al., Fatty acids content in selected edible oils (2003), Roczniki-Pastwowego-Zaklad-Higieny 54(3), pages 263-267). However, the data can vary due to the plant variety, season, origin etc. where the plant was cultivated.

It has been found that flavouring compositions with particularly advantageous sensory grill-type flavour properties are produced if the oil or fat starting product provided in step (a) comprises the following fatty acid spectrum:
3 to 14.0% by weight of palmitic acid (C16:0);
0.8 to 12.5% by weight of stearic acid (C18:0);
18.0 to 87.0% by weight of oleic acid (C18:1);
2.0 to 30.0% by weight of linoleic acid (C18:2);
0.2 to 2.2% by weight of arachidic acid (C20:0); and
0.6 to 4.0% by weight of behenic acid (C22:0);
   and optionally one or more or all of the fatty acids from the group consisting of:
0 to 6.0% by weight of butyric acid (C4:0);
0 to 2.9% by weight of caproic acid (C6:0);
0 to 65.0% by weight of caprylic acid 8:0);
0 to 45.0% by weight of capric acid C10:0);
0 to 4.5% by weight of lauric acid (C12:0);
0 to 11.5% by weight of myristic acid (C14:0);
0 to 74.0% by weight of linolenic acid C18:3);
0 to 4.3% by weight of eicosenoic acid (C20:1);
0 to 2.5% by weight of cetoleic acid (C22:1);
0 to 2.9% by weight of myristoleic acid (C14:1); and
0 to 3.9% by weight of palmitoleic acid (C16:1);
   based on the total fatty acid content, providing that the quantities indicated add up to 100% by weight.

In a preferred variant, the oil or fat starting product provided in step (a) comprises the following fatty acid spectrum:
4.0 to 8.0% by weight of palmitic acid (C16:0);
3.0 to 11.0% by weight of stearic acid (C18:0);
72.0 to 85.0% by weight of oleic acid (C18:1);
4.0 to 17.0% by weight of linoleic acid (C18:2);
1.5 to 2.0% by weight of arachidic acid (C20:0); and
2.5 to 3.5% by weight of behenic acid (C22:0);
   based on the total fatty acid content, providing that the quantities indicated add up to 100% by weight.

From the above specified vegetable oils vegetable oils with a particular high oleic and/or linoleic acid content are preferred as starting product in the method according to the present invention. Particularly preferred from the above specified vegetable oils are sunflower oil, rapeseed oil, corn oil, linseed oil and safflower oil, due to their oleic acid (18:1) and linoleic acid (18:2) content. Especially preferred as starting product is sunflower oil with a high oleic acid content. One known sunflower oil high in oleic acid has about 82% oleic acid.

The oil or fat starting material or feedstock is provided in the reservoir 2.

In the following step (b) of the method according to the present invention, the feed stream of the oil or fat starting product is introduced via the pump 3 along the first line 5 towards a heater 4 provided as a heating or reaction zone. The oil or fat starting product or feedstock can be fed to the heating or reaction zone continuously or in batches.

In the heating or reaction zone, thorough and rapid mixing occurs, and conductive heat is transferred from the heater to the oil or fat starting product or feedstock.

In the heating or reaction zone, the oil or fat starting product or feedstock is subjected to a heat treatment in which it is heated to a temperature in the range of 310° C. to 400° C. In a preferred variant of the method according to the present invention, the oil or fat starting product is heated to a temperature in the range of 350° C. to 380° C. and particularly preferably 360° C. to 370° C. Objectionable flavours develop at contact temperatures above 400° C., while at contact temperatures below 310° C., the desired flavour profile and desired concentration of flavour compound do not develop. The best contact temperature is above 360° C., but below 370° C.

The step (b) of heating the oil or fat starting product is performed at a pressure in the range of 2 to 6 bars and particularly preferably 3 to 4 bars. This improves the flow properties and acts to control the aroma.

The dwelling time of the oil or fat starting product in the heating zone is 10 to 30 seconds, preferably 12 to 28 seconds and particularly preferably 15 to 25 seconds. The dwelling time is defined as the period from the time when the feedstock comes into contact with the heater to the time when it exits the heating zone.

Aroma compositions with particularly favourable sensory properties result when the oil or fat starting product is heated in step (b) to a temperature in the range of 360° C. to 370° C. at a pressure in the range of 3 to 4 bars for 10 to 30 seconds.

It has been found that the temperature in step (b) is crucial to obtaining a harmonious and balanced grill-type flavour profile with a high impact, i.e. flavour intensity, in particular a flavour profile in which the fatty/oily and/or smoky and/or roasted and/or burnt and/or animalic flavour notes are accentuated and the waxy flavour notes are suppressed or reduced.

Using the process parameters specified above, compounds which contribute to fatty/oily and/or smoky and/or roasted and/or burnt and/or animalic flavour notes are advantageously generated in the oil or fat starting material during the heating step (b) of the method according to the present invention, namely compounds such as capric acid, oleic acid, 2E-decenal, 2E-undecenal, 2E,4E-decadienal, and 1-dodecene, while the formation of undecane, heptane, 2E-octene, 1-nonene, cyclooctene, and nonadecane, etc., which are harmful to the sensory properties, is suppressed or greatly reduced. The latter compounds may contribute to an undesired waxy flavour note.

The method according to the present invention, in particular the heating step (b), is performed in a reducing atmosphere which is either at a reduced oxygen level or substantially free of oxygen or air. No air or oxygen is supplied in the pyrolysis or thermolysis step (b). The only oxygen present is that which is necessary for purging the pressure tap, or any residual amounts of oxygen in the feedstock or that enter the system due to system limitations or leaks.

In a preferred variant, the heating step (b), i.e. pyrolysis or thermolysis is performed in the absence of oxygen or air in the reaction zone. Preferably, the process is performed without purging air.

It is preferred that the generated oil stream in the first line 5 exiting the reservoir 2 and passing the heating zone 4 is in laminar flow. Avoiding turbulences decreases friction and provides a consistent source for the atomizing device and thus predictable aroma concentrations.

Due to the absence or near-absence of oxygen in the heating or reaction zone, the process of the present invention is an endothermic pyrolysis or thermolysis and is a non-combustion process. This leads to a completely different series of chemical reactions, resulting in an aroma composition that differs from those obtained using the methods according to the prior art, as exemplified in Table 4 below.

In the heating or reaction zone 4 of the reactor 1, the oil or fat starting product or feedstock is preferably raised to the desired approach temperature by means of electrical resistance heating, indirect combustion, direct combustion or a combination of these.

In a preferred variant, the oil or fat starting product or feedstock is subjected to the high-temperature treatment in the heating zone in the form of a film (i.e. a thin layer, sheet or droplets) which maximises the exposure of the oil or fat starting product to the required temperature in order to obtain an aroma composition having the desired grill-type flavour profile. A preferred method of subjecting the oil or fat starting product to this high-temperature treatment is to employ a continuous-feed, thin-film and/or high-temperature cooking process. Alternatively, rods which are heated to within the required temperature range can be inserted into a bath of oil or fat in order to perform the high-temperature treatment.

In a preferred variant of the method according to the present invention, the oil or fat starting product or feedstock is heated by electromagnetic induction.

The process of induction heating has been used in industry for a long time and is well known to those skilled in the art. The most common applications are for melting, hardening, sintering and/or heat-treating alloys. Processes such as bonding, shrinking or joining components are however also well-known applications of this heating technology.

The principle of induction heating and the design of induction heating devices are described in the technical literature, for example in: Elektrotechnologie, edited by H Conrad, R Krampitz, VEB Verlag Technik Berlin, 1983, pages 58-114; Induktionserwärmung, G Benkowski, Berlin Verlag Technik, 1990; Practical Induction Heat Treating, R E Haimbaugh, ASM International, December 2001; Handbook of Induction Heating, V Rudnev, D Loveless, R Cook, M Black, Marcel Dekker Inc, New York and Basel, 2003.

Document DE 10 2005 051 637 describes a reactor system with a micro-structured reactor and a method for performing a chemical reaction in such a reactor. The reactor itself is heated by electromagnetic induction. The heat is transferred into the reaction medium via the heated reactor walls.

It is known from the journal article Inductive heating in organic synthesis by using functionalised magnetic nanoparticles in microreactors by S Ceylan, C Friese, Ch Lam mel, K Mazac and A Kirschning, in: Angewandte Chemie [Applied Chemistry] 2008 (129), pages 9083-9086, Angewandte Chemie international edition 2008 (47), pages 8950-8953, that chemical reactions can be performed by heating a medium with the aid of electromagnetic induction.

The principle of induction heating and the design of induction heating devices are for example described in the above-mentioned technical literature, such that the person skilled in the art who consults the available technical literature and applies their general knowledge in the art will be quite capable of installing the device for performing the method, without unreasonable effort and without performing an inventive step, and determining the optimum parameters for induction heating (for example, choosing the frequency of the reactor and inductor) in order to perform the process within the entire range under consideration.

In a preferred variant of the present application, the walls of the reactor itself are heated. The reactor therefore consists of an electrically conductive and/or magnetisable material which heats up under the influence of an alternating electromagnetic field. Preferred reactor materials include electrically conductive ceramics, such as SiC (silicon carbide), or refractory metals preferably selected from the group comprising titanium, tantalum, niobium, molybdenum, tungsten, alloys of these metals as well as nickel-based, cobalt-based and chromium-based alloys and high-temperature steels.

Heat transfer elements such as heating coils or heat exchanger tubes or plates can however also be incorporated into the reactor within the scope of the present invention.

It goes without saying that the nature of the heating medium and the design of the inductor must be adapted to each other such that the desired heating of the reaction mixture can be achieved. Critical parameters for this are on the one hand the power of the inductor expressed in watts and on the other hand the frequency of the alternating field generated by the inductor. In principle, the greater the mass of the heating medium to be inductively heated, the higher the power selected needs to be. In practice, the power which can be achieved is limited in particular by the capacity for cooling the generator which is required in order to supply the inductor.

Inductors which generate an alternating field with a frequency in the range of about 1 to about 100 kHz, preferably about 10 to about 80 kHz and particularly preferred about 10 to about 30 kHz, are particularly suitable. Such inductors and the associated generators are commercially available, for example from IFF GmbH of Ismaning, Germany.

Induction heating is thus preferably performed with an alternating field in the medium frequency range. As compared to excitation at higher frequencies, for example those in the high-frequency range (above 0.5 MHz and in particular above 1 MHz), this has the advantage that the energy input into the heating medium can be better controlled. Within the context of the present invention, it is therefore preferable to use inductors which generate an alternating field in the aforementioned medium frequency range. This allows economical and easy control of the reaction.

In order to prevent the thermal energy transferred to the reactor from being lost to convection or heat conduction through the air, the reactor can be arranged in a housing which can be evacuated. This applies to all types of reactor which can be used in the process of the present invention. An evacuated housing offers the additional advantage that any leakage in the reactor can be easily detected analytically or can be quickly detected due to a pressure increase inside the housing. It also prevents toxic chemical compounds, escaping through a leak, from emerging directly into the atmosphere.

The reactor housing can for example be an elongated glass, quartz glass or ceramic housing. This housing can be provided with a heat-reflecting cover on the inside to minimise losses due to heat radiation. This coating preferably does not consist of an electrically conductive material, in order to prevent it from heating up while induction heating is performed using the energy field. Additionally, or alternatively, a heat-reflecting internal coating can also be provided in the evacuated zone and can be made of the same materials as the heat-reflecting coating of the reactor housing. The housing can also be self-cooled, for example using water or air.

Once the oil or fat starting material has been heated under the aforementioned conditions, a heated and pressurised oil stream containing pyrolysis products is obtained and leaves the heating or reaction zone.

In the process step (c), the heated and pressurised oil stream containing pyrolysis or thermolysis products is then piped through the first line 5 to an atomizing device, which can be a nozzle 6, for atomising or vaporising the heated oil stream and fragmenting the oil stream into a liquid oil phase and an aerosol comprising an aroma composition having a grill-type flavour profile.

It is preferred that the generated oil stream piped through the first line 5 and exiting the heating zone 4 is in laminar flow. Avoiding turbulences decreases friction and provides a consistent source for the atomizing device and thus predictable aroma concentrations.

The term “atomisation” refers to separating substances into fine particles; it is a process of breaking bulk liquids into small droplets, thus producing an aerosol. An aerosol is defined as a suspension system of solid or liquid particles in a gas. An aerosol includes both the particles and the suspending gas, which is usually air. The atomizing device is preferably a nozzle.

A nozzle is a mechanical device such as a pipe or tube exhibiting a variable cross-sectional area wherein the change in cross-sectional area affects an exchange of pressure and ejection velocity.

Thus, in a nozzle, the velocity of the fluid increases rapidly at the expense of its pressure energy. When a nozzle is placed on a pipe, the flow nozzle causes a drop in pressure which varies with the flow rate. This can be used to atomize a fluid, such as with a spray nozzle.

Typically, the diameter of the nozzle tube gradually decreases from a starting point to the end of the nozzle. Other designs are possible, but a release of fluids or gases from a confined tube into a free airspace is conventional. At the starting point, where the cross-sectional area is high, the pressure is high and the velocity is low, but towards the end of the nozzle, when the cross-sectional area decreases, the pressure decrease and the velocity increases. After leaving the nozzle, the ejected driving fluid or motive (steam, pressurised liquid or air) has a considerably higher velocity. When the heated and pressurized fluid is passed through the body of the nozzle into a free airspace, a partial drop in pressure occurs. Once the vapour pressure is reached, evaporation occurs. Due to the difference in pressure which exists, the bubbles burst outside the nozzle, fuelling the disintegration of the heated and pressurised oil stream. This results in two phases: a vapour phase (aerosol) enriched in the more volatile components, and a liquid oil phase, enriched in the less volatile components. The vapour phase (aerosol) and the liquid oil phase are separated by gravimetry. The vapour is taken off overhead, while the liquid drains to the bottom, where it is withdrawn.

Spray nozzles can be categorized based on the energy input used to cause atomization, which is the breakup of the fluid into drops. Spray nozzles can have one or more outlets; a multiple outlet nozzle is known as a compound nozzle. Single-fluid or hydraulic spray nozzles utilize the kinetic energy of the liquid to break it up into droplets.

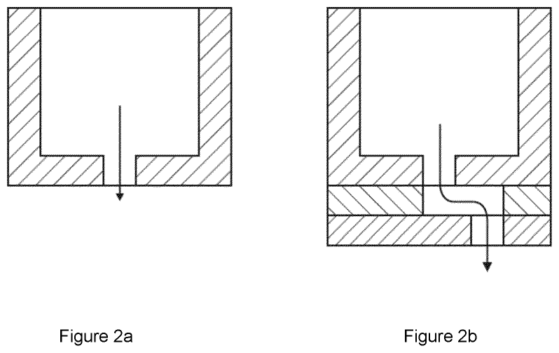

When a fast liquid stream is injected into the atmosphere through a nozzle, it causes a pressure difference between the liquid in the pipe and the lower pressure in the gas stream, in accordance with Bernoulli's principle. The difference between the reduced pressure outside the nozzle and the higher pressure inside the nozzle pushes the liquid from the first line 5 through the nozzle 6 and into the moving stream of air, where it is broken up into small droplets (though not individual atoms, as the term may suggest) or atomised. Presently, the atomizer used can be a simple plain orifice nozzle. Such a plain orifice nozzle is shown in FIGS. 2a and 2b.

Different types of atomiser or nozzle can be used to generate aerosols. Atomisers or nozzles are classified as mechanical or pneumatic atomisers or nozzles depending on their energy supply. Rotary or ultrasonic sprayers are classified into the first group. The disintegration of a liquid by pneumatic atomisers or nozzles is caused by aerodynamic interactions between the gas and liquid phase. Jet nozzles, turbulence nozzles and lamellar nozzles are distinguished according to the primary liquid structure at the back of the atomiser or nozzle. The aerodynamic interaction characteristics of two-component nozzles are enhanced by using an additional gas.

Nozzles which are based on atomising a fluid without using an additive are called single-component nozzles. They are characterised by their simple construction. Pressure energy is converted into kinetic energy. Turbulence nozzles are similarly the geometrically simplest atomisers. The formation of turbulence in the nozzle is specifically stimulated by guiding the flow of the liquid in the nozzle. The difference in velocity between the environment and the liquid jet leaving the nozzle causes interactions between the phases. Inhomogeneities in the jet, caused by the turbulence generated in the nozzles, are amplified and result in the liquid disintegrating. Hole-type nozzles or elbow nozzles are examples of the aforesaid nozzles (see FIGS. 2a and 2b). Single-component and turbulent nozzles can afford different aroma profiles due to higher mixing rates in the stream.

Lamellar nozzles are used to generate finer sprays using moderate pressures. Unlike turbulence nozzles, in which the liquid is shaped into a jet, lamellar nozzles are distinguished by the fact that the nozzle shape used forms the liquid into a lamella, which ultimately disintegrates into droplets. Examples include flat-jet nozzles and hollow-cone nozzles. These are also preferred presently to afford a higher distribution of aerosol vs. liquid oil phase that is recycled.

In the airless atomisation process, high pressure forces fluid through a small nozzle. The fluid emerges as a solid stream or sheet at high speed. The friction between the fluid and the air disrupts the stream, breaking it up initially into fragments and ultimately into droplets. The energy source for this form of atomisation is fluid pressure which is converted into momentum as the fluid leaves the nozzle. Three factors that affect an airless spray include the diameter of the atomiser orifice, the atmosphere and the relative velocity between the fluid and the air. With respect to the orifice diameter, the general rule is that the larger the diameter or size of the atomiser orifice, the larger the average droplet size in the spray. The atmosphere provides resistance and tends to break up the stream of fluid. This resistance tends to partially overcome the fluid's properties of surface tension, viscosity and density. The air temperature can also affect atomisation. The relative velocity between the fluid and the air also affects droplet size. The fluid's velocity is created by pressure in the nozzle. As the fluid pressure increases, the velocity increases and the average droplet size decreases; conversely, as the fluid pressure decreases, the velocity is lower and the average droplet size is greater. Airless nozzles are possible to use in the present invention.

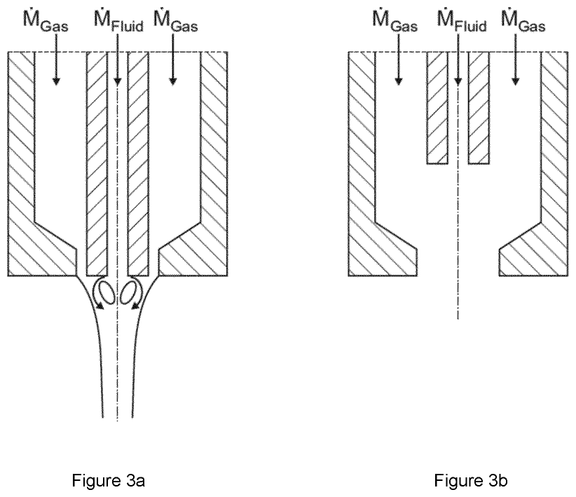

Another preferred way of influencing the size distribution of droplets is to use an additive, usually an inert atomiser gas. The relative velocity between the liquid phase and gas phase, which is increased by the additive gas component, increases the momentum exchange and leads to more intense turbulence in the liquid jet to be atomised. The geometry of the nozzles is dependent on the type of gas supply. If the gas and the liquid to be atomised come into contact outside the nozzle, this is called external mix atomisation (see FIGS. 3a and 3b). In the simplest case, the liquid is fed centrally into a jet of gas. The liquid and the gas flow out of the nozzle at different velocities. Momentum exchange between the more slowly flowing liquid and the more quickly flowing gas accelerates the liquid. These types of nozzles with additive gases can be used to atomize the oil stream.

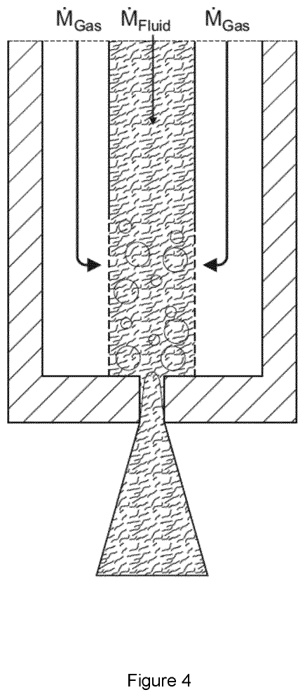

In the case of internal mix nozzles, the atomiser gas is supplied in the interior of the nozzle (see FIG. 4). The introduced gas component generates turbulence in the multi-phase flow, which promotes instability and thus the disintegration of the liquid. These types are preferred to generate fine aerosol distributions and greater output of the reactor.

In air-spray atomisation, fluid emerging from a nozzle at low speed is surrounded by a high-speed stream of air. Friction between the liquid and the air accelerates and disrupts the fluid stream, causing atomisation. The energy source for air atomisation is the air pressure. The operator can regulate the flow rate of fluid independently of the energy source. FIG. 4 shows a stream of fluid passing through an orifice; as it emerges, a high-speed stream of air surrounds the fluid stream.

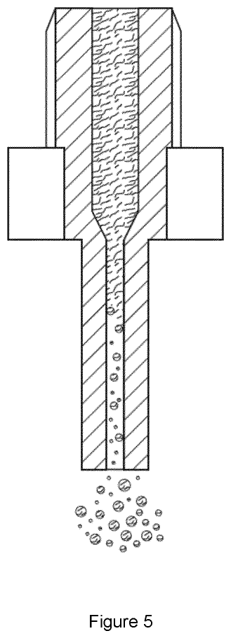

Effervescent atomisation is a special type of atomisation in which gas is guided internally. The essential structure of the nozzle is shown in FIG. 5. The gas phase is added in a mixing chamber. The resultant two-phase flow exists as a bubbly flow in the mixing chamber. A slug flow or annular flow is generated at the nozzle exit. Outside the nozzle, the thin annular lamella of liquid is disintegrated into droplets by the gas phase flowing at high speed at the centre of the nozzle. Thus, this nozzle arrangement is also preferred for greater mixing.

Superheated or flash atomisation is a special way of generating aerosols. Simple pressure nozzle geometries are used. A liquid stream containing several components is partially vaporised in a flash drum at a certain pressure and temperature. This results in two phases: a vapour phase (aerosol) enriched in the more volatile components, and a liquid phase, enriched in the less volatile components. The fluid is heated and pressurized and is then passed through a nozzle into the flash drum. A partial drop in pressure occurs as the fluid flows through the body of the nozzle. Once the vapour pressure is reached, evaporation occurs. Due to the difference in pressure which exists, the bubbles burst outside the nozzle, fuelling the disintegration of the liquid stream. The vapour is taken off overhead, while the liquid drains to the bottom of the drum, where it is withdrawn. An additional gas additive is not needed for disintegrating the liquid, since the gas and/or vapour phase comes directly from the atomiser liquid. The high temperatures of the atomiser liquid reduce the viscosity and surface tension of the liquid. This promotes the generation of small droplets. As superheating increases, a finer spray is generated. Again, this is a preferred method as finer droplets are generated by such atomisation.

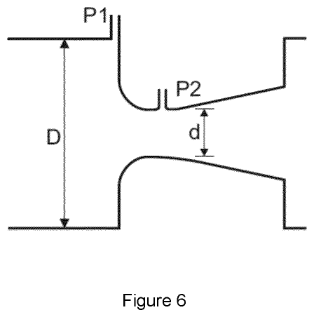

In a more preferred variant of the method according to the present invention, the heated oil stream is atomised or vaporised and thereby fragmented into a liquid oil phase and an aerosol comprising an aroma composition having a grill-type flavour profile using a Venturi nozzle (see FIG. 6).

A Venturi nozzle consists of three parts: a nozzle, a body and a diffuser or a constriction point. The Venturi nozzle is a mechanical device such as a pipe or tube exhibiting a variable cross-sectional area wherein the change in cross-sectional area effects an exchange of pressure and temperature for ejection velocity. Typically, the diameter of the nozzle tube gradually decreases from a starting point to a constriction point of the nozzle after which the diameter increases again rapidly towards the end of the nozzle (see FIG. 6). That construction builds backpressure up-stream and effects a negative pressure down-stream of the constriction. As the volume of fluid is forced through the reduced diameter fluid dynamic laws determine that the increased flow velocity be accompanied by a pressure drop. Thus, the ejection speeds are high which coincides with a fast drop in pressure and temperature. This process leads to a particularisation of the ejected fluid.

Of the above types of nozzle, flash atomisation or Venturi nozzles are particularly preferred used in the method according to the present invention.

The properties of the aerosol generated depend significantly on the nozzle geometry and the fluid properties of the atomiser liquid. These factors influence both the flow through the nozzle and the behaviour of the clusters of droplets after they exit the nozzle. In the capillary, the hydrodynamics are determined by changes in cross-section (flow constriction, loss of pressure), unevenness (friction) and the properties of the atomiser liquid. Additionally, a variety of factors affect droplet size and the ease with which a stream of liquid atomises after emerging from an orifice. These factors including the fluid properties of surface tension, viscosity and density.

The diameter of the nozzle tube in the method according to the present invention is preferably 1.2 to 3.0 mm, more preferably 1.5 to 2.8 mm and most preferably 2.0 to 2.3 mm.

Through atomisation or vaporisation by a nozzle, the heated and pressurised oil stream is fragmented into two inhomogeneous phases: a vapour phase with finer droplets (aerosol) enriched in the more volatile components constituting the aroma composition having a grill-type flavour profile, and a liquid phase, enriched in the less volatile components. In the fragmented bigger droplets of the liquid oil phase however, less volatile compounds are contained. The aerosol with the finer droplets and the phase with the bigger oil droplets are separated by gravimetry. The vapour is taken off overhead, while the liquid drains to the bottom of the drum, where it is withdrawn.

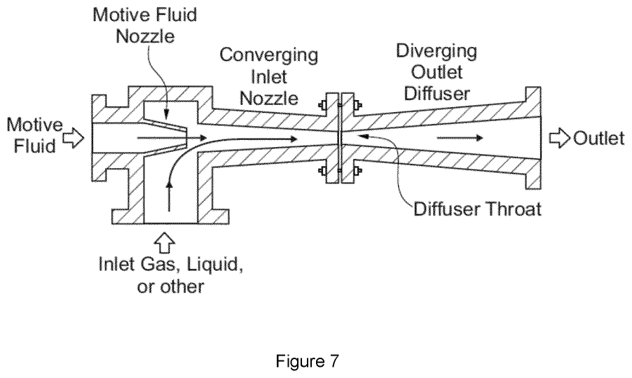

In order to improve the atomisation of the oil stream and thereby the fragmentation of the oil stream into a liquid oil phase and an aerosol comprising the aroma composition having a grill-type flavour profile, and/or to increase the velocity of the aerosol stream and, thus, to accelerate the transport of the aerosol stream to the container 11, the body of the nozzle, preferably the Venturi nozzle, is preferably provided with an inlet 7, as it is schematically depicted in FIG. 7.

Via this inlet, gas or fluid is injected or sucked via a suction chamber adjacent to the nozzle exit, creating suction flow. The driving fluid or motive (steam, pressurised liquid or air) passes through the nozzle of the ejector. By increasing the velocity of the fluid as it passes through the nozzle, a low-pressure region or suction flow at the exit of the nozzle is created within the ejector. This low pressure region entrains and compresses the secondary gas or fluid, i. e. the suction gas or fluid stream. The motive stream (steam, pressurised liquid or air) and the suctioned gas or fluid stream are mixed. As the combined driving fluid and secondary gas or fluid streams pass through an ejector's diffuser section, the velocity decreases and the pressure is regained, so that the fluid is discharged from the ejector with a backpressure.

In a preferred variant of the method, atomisation is performed using as injection gas an inert gas, such as nitrogen, or air.

Alternatively, a vacuum is applied to the nozzle or adjacent to the nozzle exit, creating a suction flow, via this inlet 7 and controlled by a vacuum control unit 8. Applying a vacuum, preferably at a pressure of 200 to 800 mbar, more preferably at a pressure of 300 to 600 mbar, most preferably at a pressure of 450 to 500 mbar, increases the velocity of the motive stream (steam, pressurised liquid or air) through a drop in pressure.

Both of the described configurations of the nozzle promote atomisation of the (preferably laminar) oil stream on the one hand and improve the transport or evacuation of aerosol charged with the aroma composition on the other hand.

Therefore, in preferred variants of the method according to the present invention the atomizing device is characterised by injecting a fluid or gas adjacent to the nozzle exit or applying a vacuum at a pressure of 200 to 800 mbar adjacent to the nozzle exit.

Driving the heated and pressurised (preferably laminar) oil stream containing pyrolysis products, produced in method step (b), through any of the nozzles described above, atomises or vaporises it by virtue of the nozzle and thus fragments it into a liquid oil phase and an aerosol comprising the aroma composition having a grill-type flavour profile.

Due to the ejection of the heated and pressurised fluid into a free airspace, and the thus resulting partial drop in pressure, the temperature of the aerosol decreases compared to the contact temperature of the oil stream in the heating zone of the reactor. The temperature of the aerosol close to the nozzle exit is in a range from 180 to 230° C., preferably in a range from 200 to 210° C.

In the following step (d), the resultant aerosol comprising the aroma composition having a grill-type flavour profile is discharged with the stream and transferred to a second line 9. The liquid oil phase separated from the aerosol is transferred to a third line 10.

In a further preferred variant of the method according to the present invention, a vacuum can be applied to the discharge line 9, creating a suction flow or low pressure, in order to accelerate the transport of the aerosol comprising the aroma composition having a grill-type flavour profile to the container 11, and controlled by a vacuum control unit. Applying a vacuum, preferably at a pressure of 200 to 800 mbar, more preferably at a pressure of 300 to 600 mbar, most preferably at a pressure of 450 to 500 mbar, increases the velocity of the aerosol.

In the following method step (e), the aerosol comprising the aroma composition having a grill-type flavour profile is discharged from the reactor and either collected in a collection vessel or absorbed on a solid carrier or liquid carrier.

A solid carrier is preferably used in a finely granulated or powder form which is preferably dry. Examples of materials suitable for the food industry include saccharides, polysaccharides and starches such as potato starch, rice starch, corn starch, etc., for example maltodextrin. Other powdered, finely divided food additives/ingredients may be used, such as for example silicas. Salts, sugar and/or spices or spice extracts are also particularly suitable. The carrier is suitably a liquid carrier. Oil-based or water-based carriers are preferred, depending on the ultimate use of the food ingredients. Water is a preferred carrier. Oils and mixtures of oils are particularly preferred.

A long shelf life is desirable in food products; to this end, dry solid carriers in powder form are preferred, as are stable oils. The latter are usually relatively low in polyunsaturated and monounsaturated fats/fatty acids and high in saturated fats/fatty acids. The oils preferably have a low level of oxidation.

Carrier oils suitable for the present invention include high-stability vegetable oils, i.e. saturated or partially saturated vegetable oils. Preferred oils include palm oil, soybean oil, peanut oil, olive oil, rapeseed oil, grapeseed oil, canola oil, corn oil, coconut oil, sesame oil, poppyseed oil, safflower oil, pumpkin seed oil, rice bran oil, almond oil, pecan oil, macadamia oil, pig fat (lard), beef fat (tallow), mutton fat (tallow), bacon dripping, chicken fat, turkey fat, butter or mixtures of two or more of these oils and/or fats.

More specifically, the carrier is preferably an oil having a high saturated fat content: high saturated fatty acid levels improve stability. Known saturated fat levels are: approximately 86 to 92% saturated fat for coconut; approximately 50 to 68% saturated fat for butter; approximately 39% saturated fat for lard; approximately 14% saturated fat for olive oil; and approximately 14% saturated fat for sesame. High levels are those which are 10% and above, preferably 30% and above. All of these oils can also be used as the oil or fat starting product or as part of the oil or fat starting product. The quality of the sunflower oil may also specifically be assessed on the basis of its ratio of oleic to linoleic acid. The fatty acid composition of sunflower oil is commonly 55 to 65% linoleic acid and 20 to 30% oleic acid, the remainder including other fatty acids, primarily palmitic acid and stearic acid. Sunflower oil is regarded as a stable oil, and most versions of it can be used in the invention. Particular versions used in the invention preferably contain even higher levels of oleic acid, particularly at least 50% oleic acid, more preferably at least 60% and even more preferably at least 70%. One known sunflower oil high in oleic acid has about 82% oleic acid.

Oils with lower levels of saturates, which are generally less useful as stable carrier oils but may be acceptable if stability is less of a required feature, include avocado oil, fish oil, linseed oil and some nut oils, including peanut oil.

Examples of preferred stable carrier oils include oils with a high oleic acid content, such as sunflower oil, lard, tallow and olive oil, and oils with a saturated fatty acid content of 20% or more, preferably 35% or more.

In the collection vessel or through absorption of the aerosol on a solid carrier or liquid carrier, the temperature of the aerosol further decreases, so that the aerosol condenses, and, thus liquefies. Thus, an active cooling of the aerosol in the method according to the present invention is not required.

The concentration of the aerosol in the solid carrier or liquid carrier is at least 0.5% by weight, based on the total weight of the aerosol/carrier composition. Preferably, the content of the aerosol in the solid carrier or liquid carrier is 1.0 to 10% by weight or more, based on the total weight of the aerosol/carrier-composition. The above ranges relate to an aerosol content preferably after 4 cycles.

The excess flowback liquid oil phase obtained by atomising and fragmenting the (preferably laminar) oil stream flows along the third line 10 and is collected in a process oil collection vessel 12. The excess flowback liquid oil phase can be recycled to the process oil reservoir 2 several times by means of pumps.

The reactor can also be run continuously, which is more efficient.

It has surprisingly been found that an aroma composition having a grill-type flavour profile with a pronounced impact and enhanced fatty/oily and/or smoky and/or roasted and/or burnt and/or animalic flavour notes but with a reduced waxy flavour note is achieved if the flowback liquid oil phase is subjected to the method according to the present invention several times. 2 to 25 cycles are possible with 2 to 6 being better.

In a more preferred variant of the method according to the present invention, the excess flowback liquid oil phase is recycled in an undiluted form, two to five times. In a particularly preferred variant, the flowback liquid oil phase is subjected to the method according to the present invention two to four times. In a most preferred variant, the flowback liquid oil phase is subjected to the method according to the present invention three or four times.

In a continuous operation of the method according to the present invention, the cycle time is calculated based on the time period required for one passage, dependent on the pumping speed.

It has surprisingly been found that if two to four cycles of the liquid oil phase are performed in the method according to the present invention, a significant increase of the compounds which contribute to a grill-type flavour profile with fatty/oily and/or smoky and/or roasted and/or burnt and/or animalic flavour notes is advantageously obtained, namely compounds such as capric acid, oleic acid, 2E-decenal, 2E-undecenal, 2E,4E-decadienal, and 1-dodecene, as shown in Table 4. However, if the liquid phase is subjected to the method according to the present invention four to six times, only a negligent increase of the compounds which contribute to a grill-type flavour profile is obtained.

This has also been confirmed in a comparative taste test panel, in which it was noted that the flavour profile of the aroma composition of the present invention was more enhanced and richer and higher in concentration. As shown in FIG. 7, the impact and fatty/oily and/or smoky and/or roasted and/or burnt and/or animalic flavour notes in particular are enhanced, while the waxy flavour note is significantly reduced as compared to the aroma composition of WO 2019/141357.

By contrast, in the method according to WO 2019/141357, the pyrolised or thermolised oil feedstock is not separated by atomization and, thus, fragmented but used as such. By the method according to the present invention, however, atomization and, thus, fragmentation of the pyrolised or thermolised oil feedstock into two phases is obtained. This results in an aerosol, which is more enhanced and richer in volatile compounds and which is advantageously not diluted with the oily phase, resulting in a higher flavour concentration and, thus, intensity.

The ratio of the amount of educt (aerosol), enriched in the more volatile components constituting the aroma composition having a grill-type flavour profile to the amount of the (recycled) liquid oil phase amounts 1:99, preferably 1:95.

In a second aspect, the present invention relates to an aroma composition having a grill-type flavour profile obtainable using the method according to the present invention, as described above.

The present invention thus relates to an aroma composition having a grill-type flavour profile obtainable by a method comprising or consisting of the following sequence of steps:
(a) providing a vegetable or animal oil or fat or a mixture thereof;
(b) transferring the product of step (a) to a reactor and heating the product to a temperature in the range of 310° C. to 400° C., in particular in the range of 350° C. to 380° C., and a pressure in the range of 2 to 6 bars, to obtain an oil stream;
(c) atomising the oil stream, thereby fragmenting the oil stream into a liquid oil phase and an aerosol comprising an aroma composition having a grill-type flavour profile, by an atomising device, preferably by a nozzle;
(d) transferring the aerosol containing the aroma to a second line and transferring the liquid oil phase to a third line;
(e) discharging the aerosol containing the aroma by collecting the aerosol or absorbing the aerosol on a solid carrier or in a liquid carrier; and
(f) optionally returning the liquid oil phase from step (d) to the reactor.

Preferably, the aroma composition obtained can be in combination with a solid or liquid carrier and/or other suitable food additive.

The aroma compositions having a grill-type flavour profile produced using the present invention have a high impact and marked characteristics. It has surprisingly been found that the aroma compositions according to the invention have a harmonious and balanced grill-like aroma profile. The aroma compositions according to the invention have improved sensory properties and are characterised by the fact that they provide and/or enhance fatty/oily and/or smoky and/or roasted and/or burnt and/or animalic flavour notes and suppress or reduce waxy flavour notes.

It has also surprisingly been found that the manufacturing process according to the invention prevents or suppresses or greatly reduces the formation of undecane, heptane, 2E-octene, 1-nonene, cyclooctene, and nonadecane, etc., which are harmful to the sensory properties.

The aroma composition described in the present application has flavouring notes which are markedly different from those obtained using the process described in WO 2019/141357, as can be seen from Table 4, even when using the same feedstock. In a comparative test in particular, the formation of compounds which contribute to a grill-type flavour profile, namely fatty/oily and/or smoky and/or roasted and/or burnt and/or animalic flavour notes, is enhanced; such compounds include capric acid, oleic acid, 2E-decenal, 2E-undecenal, 2E,4E-decadienal, and 1-dodecene, as can also be seen from Table 4. In comparison thereto, the aroma composition obtained using the process described in WO 2017/141357, however, comprises less grill-type flavours, such as fatty/oily, smoky, roasted and burnt, while the waxy and soapy aroma components are enhanced.

The aroma composition produced by the method described above can be determined using a standard analytic method such as gas chromatography.

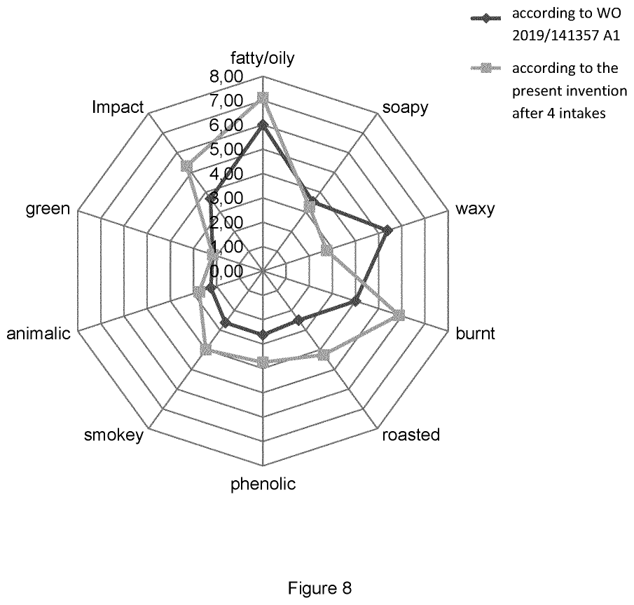

In a comparative taste test panel in particular, it was noted that the flavour profile of the aroma composition of the present invention was more enhanced and richer and higher in concentration. As shown by the spider diagram in FIG. 8, the impact and fatty/oily and/or smoky and/or roasted and/or burnt and/or animalic flavour notes in particular are enhanced, while the waxy flavour note is significantly reduced, as compared to the aroma composition of WO 2019/141357.

The aroma composition according to the present invention having an improved grill-type flavour preferably comprises:
(a) at least one, preferably two, type(s) of linear or branched, saturated or unsaturated aliphatic C8 to C20 monocarboxylic acids;
(b) at least one, preferably two, type(s) of α,β-unsaturated C6 to C14 aldehydes; and
(c) at least one, preferably two, type(s) of α,β-unsaturated C6 to C14 alkenes.

The at least one type of linear of branched, saturated or unsaturated aliphatic C8 to C20 monocarboxylic acids is preferably selected from the group consisting of octanoic acid, nonanoic acid, decanoic acid, undecanoic acid, dedecanoic acid, tridecanoic acid, tetradecanoic acid, pentadecanoic acid, hexadecanoic acid, heptadecanoic acid, octadecanoid acid, nonadecanoic acid and eicosanoic acid.

The at least one type of α,β-unsaturated C6 to C14 aldehydes is preferably selected from the group consisting of C6-aldehyde, C7-aldehyde, C8-aldehyde, C9-aldehyde, C10-aldehyde, C11-aldehyde, C12-aldehyde, C13-aldehyde and C14-aldehyde.

The at least one type of α,β-unsaturated C6 to C14 alkenes is preferably selected from the group consisting of hexene, heptene, octene, nonene, decene, undecene, dodecene, tridecene and tetradecene.

In a more preferred variant of the present invention, component (a) in the aroma composition according to the present invention is selected from the group consisting of capric acid and oleic acid, and/or component (b) is selected from the group consisting of 2E-decenal, 2E-undecenal and 2E,4E-decadienal, and/or component (c) is selected from the group consisting of 1-dodecene. These compounds mainly contribute to fatty/oily and/or smoky and/or roasted and/or burnt and/or animalic flavour notes.

In another preferred variant, the components (a) and (b) and (c) are present in the aroma composition of the present invention in a weight ratio of 4.5 to 6.5:6.5 to 8.5:4.5 to 6.5, preferably in a weight ratio of 5.0 to 6.0:6.0 to 8.0:5.0 to 6.0.

In a more preferred variant, the aroma composition of the present invention comprises the following components:
capric acid at ≥150 ppm, in particular ≥230 ppm;
oleic acid at ≥250 ppm; in particular ≥350 ppm;
2E-decenal at ≥30 ppm, in particular ≥400 ppm; and
1-dodecene at ≥50 ppm, in particular ≥120 ppm.

In a particular preferred variant, the aroma composition of the present invention comprises the following components:
capric acid at ≥200 ppm, in particular ≥230 ppm;
oleic acid at ≥250 ppm; in particular ≥350 ppm;
2E-decenal at ≥400 ppm, in particular ≥650 ppm;
2E-undecenal at ≥220 ppm, in particular ≥400 ppm;
2E,4E-decadienal at ≥20 ppm, in particular ≥100 ppm; and
1-dodecene at ≥50 ppm, in particular ≥120 ppm.

As can be seen from Table 4, the aroma profile of the aroma composition having a grill-type flavour profile according to the present invention, is distinguished by the content of at least one type of linear or branched, saturated or unsaturated aliphatic C8 to C20 monocarboxylic acids, such as capric acid and oleic acid; at least one type of α,β-unsaturated C6 to C14 aldehydes, such as C6-aldehyde, C7-aldehyde, C8-aldehyde, 2E-heptenal, C9-aldehyde, 2E-oxtenal, 2E-nonenal, 2E-decenal, 2E-undecenal, 2E,4E-decadienal and 8Z-Heptadecenal; and at least one type of α,β-unsaturated C6 to C14 alkenes, such as 2E-hexen, 11-hexen, 1-hepten, 1-octene, 4E-decen, 1-dodecene, 1,3E-undecadiene and 8Z-heptadecene.

In a preferred variant, the grill-type flavour profile of the aroma composition is characterised by a significant content of capric acid, oleic acid, 2E-decenal, 2E-undecenal, 2E,4E-decadienal, and 1-dodecene, as described above. The concentration of said aldehydes and alkenes in the aroma composition is by a factor of at least 10 considerably higher compared to the aroma composition according to WO 2019/141357 A1, as can be derived from Table 4. This also applies to the concentration for capric acid and oleic acid, where the factor is at least 2.

The aroma composition produced using the present invention is very strong and distinctive. Due to its distinguishing properties and grill-type flavour profile, another aspect of the present invention relates to the use of the aroma composition for providing or enhancing a grill-type flavour and in particular imparting fatty/oily and/or smoky and/or roasted and/or burnt and/or animalic flavour notes and for simultaneously suppressing and/or reducing waxy flavour notes in a foodstuff, food supplement or animal feed and/or for preparing a foodstuff, food supplement or animal feed.

The aroma composition can be used in its own right or in combination with other flavourings, resulting in a blended product. The aroma composition of the present invention can also be used together with an appropriate liquid or solid carrier such as maltodextrin, starches or other carriers described in detail above or with one or more other suitable food additives as a flavouring agent. This flavouring agent may take the form of a liquid, solid, sauce, cream, pare or powder.

The aroma composition according to the present invention, or blended products or flavouring agents containing said aroma composition, can then be applied to meat, poultry, fish/seafood and/or other foodstuffs, including but not limited to dairy products, vegetables, deep-fried, surface-fried, baked, microwaved, barbequed, grilled or snack foods, in which it is desirable to impart or enhance a grill-type flavour.

Another aspect of the present invention therefore relates to a foodstuff, food supplement or animal feed comprising the aroma composition according to the present invention. The foodstuff is selected from, but not limited to, meat, poultry, fish/seafood, dairy products, vegetables, deep-fried, surface-fried, baked, microwaved, barbequed, grilled or snack foods. The aroma composition, or blended products or flavouring agents containing said aroma composition, are added to the foodstuff, food supplement or animal feed in a concentration sufficient to impart a grill-type flavour to said products. The aroma composition, or blended products containing said aroma composition, is/are in particular added to said consumer products in an amount of 0.01 to 0.3% by weight, preferably in an amount of 0.02 to 0.2% by weight, most preferably in an amount of 0.1%, based on the total weight of the formulation.

Finally, the present invention relates to an apparatus for producing an aroma composition having a grill-type flavour profile, with a reactor 1 comprising:
(i) a reservoir 2 for the vegetable or animal oil or fat or a mixture thereof, a pump 3, and a heater 4 adapted to heat the vegetable or animal oil or fat or mixture thereof to generate a heated oil stream;
(ii) an atomizing device, preferably a nozzle 6, adapted to atomise the heated oil stream in order to fragment the oil stream into a liquid oil phase and an aerosol comprising the aroma composition having a grill-type flavour profile;
(iii) optionally an inlet 7 adapted to inject a fluid or gas adjacent to the nozzle exit or to apply a vacuum adjacent to the nozzle exit;
(iv) a second line 9 adapted to discharge the aerosol containing the grill-type flavour;
(v) a third line 10 adapted to return the liquid oil phase to the reactor;
(vi) a container 11 adapted to collect the aerosol; and
(vii) a collection vessel 12 adapted to collect the liquid oil phase.

In a preferred variant of this apparatus, the heater 4 is an induction heater. This provides a smoother heating profile.

In a more preferred variant of the apparatus, the nozzle 6 is a Venturi nozzle, an example of which is depicted in FIG. 6.

Additional preferred variants and configurations of the apparatus according to the present invention are described in connection with the method according to the present invention.

### LIST OF REFERENCE SIGNS

1 reactor
2 reservoir
3 pump
4 heater
5 first line
6 nozzle
7 inlet
8 vacuum control unit
9 second line
10 third line
11 container
12 collection vessel
13 exhaust air/partial vacuum

### Example 1: Characterisation of the Reaction Product

Each 0.5 g samples of the product (sunflower oil with a high oleic acid content) were extracted in 2 g water with 100 ppm 2-nonanol as internal standard, 1 h by SBSE (Stir Bar Sorptive Extraction) (Twister) and analysed using GS/MS.

One sample relates to an aroma composition prepared according to the present invention in which the liquid oil phase was recycled two times; another sample relates to an aroma composition prepared according to the present invention in which the liquid oil phase was recycled four times; and yet another sample relates to an aroma composition prepared according to the present invention in which the liquid oil phase was recycled six times.

For comparison, a sample of an aroma composition prepared according to the method of WO 2019/141357 A1 using the same feedstock, was prepared.

| | |
|---|---|
| Instruments: | |
| Mass spectrometer: | Aglient MSD 5977B |
| Gaschromatograph: | GC Agilent 8890 |
| Autosampler: | MPS Robotic with TDU Option |
| Application system: | Gerstel TDU2 (Twister Desorption Unit) |
| | with Cooled Injection System (CIS) |

TDU_40_3_230_S10_150° C. M:
40° C. (1 min isotherm)-3° C./min-230° C. (25 min isotherm)
Split: 1:10 (TDU max temperature: 150° C.)

| | |
|---|---|
| GC: | |
| Oven Temperature | -> 40° C. |
| (Initial) | |
| Program | |
| #1 Rate | 3° C./min |
| #1 Value | 230° C. |
| #1 Hold Time | 30 min |
| Front PTV Inlet He | |
| Mode | Solvent Vent |
| Pressure | On 19.024 psi |
| Total Flow | On 29.4 mL/min |
| Septum Purge Flow | On 3 mL/min |
| Gas Saver | On 15 after 2 min mL/min |
| Purge Flow to Split Vent | 24 mL/min at 0.03 min |
| (split 1:10) | |
| Column Information | Agilent CP9205 VF-WAXms |
| Temperature Range | 20-250° C. (260° C.) |
| Dimensions | 30 m × 250 μm x 0.25 μm |
| In | Front PTV Inlet He |
| Out | MSD |
| (Initial) | 40° C. |
| Flow | 2.4 mL/min |
| Control Mode | Constant Flow |
| Front Detector FID | |
| Makeup | N2 |
| Heater | On 300° C. |
| H2 Flow | On 35 mL/min |
| Air Flow | On 350 mL/min |
| Makeup Flow | On 25 mL/min |
| Carrier Gas Flow Correction | Constant Makeup and Fuel Flow |
| Flame | On |
| MSD Transfer Line | |
| Temperature | 280° C. |
| (Initial) | |
| FID Signals | |
| Signal #1 | Front Signal (FID) |
| Data Rate | 20 Hz |
| GERSTEL CIS | |
| Temperature program: | |
| Initial Temperature | −20° C. |
| Equilibration Time | 1.00 min |
| Initial Time | 0.10 min |
| Ramp 1 | |
| Rate | 12.00° C./s |
| End Temperature | 250° C. |
| Hold Time | 10.00 min |
| GERSTEL TDU | |
| Temperature program: | |
| Initial Temperature | 30° C. |
| Delay Time | 1.00 min |
| Initial Time | 0.00 min |
| Ramp 1 | |
| Rate 1 | 60.0° C./min |
| End Temp 1 | 150° C. |
| Hold Time 1 | 8.00 min |
| TDU SETTINGS | |
| Transfer Temperature | 260° C. |
| Transfer Temp. Mode | Fixed |
| Desorption Mode | Splitless |
| Sample Mode | Remove Tube-no Standby Cooling |
| Standby Temperature | 50° C. |
| General Information | |
| Scan Parameters: | |
| Low Mass | 25 |
| High Mass | 370 |
| MSZones: | |
| MS Source | 230° C., maximum 250° C. |
| MS Quad | 150° C., maximum 200° C. |

The results of the gas chromatography are indicated in Table 4 below.

TABLE 4

| | | | | | | | Grill-type | according to | according to | according to |
|---|---|---|---|---|---|---|---|---|---|---|
| | | | | | | | aroma | invention, | invention, | invention, |
| | | | | | | | according to | recycled | recycled | recycled |
| sorted according to | | | | | | | WO2019/141357 A1 | 2 times | 4 times | 6 times |
| order of elution (index) | Threshold | MS | Index | Index | | | SBSE | SBSE | SBSE | SBSE |
| Name MI | [ppb] | No. | L | DA | Scan | Time | [ppm] | [ppm] | [ppm] | [ppm] |
| 1-Pentene | | E2860 | 1 | 499 | 82 | 2.354 | 0.000 | 7.805 | 0.000 | 0.000 |
| 2E-Hexene | | E2776 | 1 | 510 | 104 | 2.327 | 0.000 | 0.000 | 114.498 | 0.000 |
| 1-Hexene | | E2802 | 1 | 542 | 112 | 2.354 | 0.000 | 69.022 | 113.003 | 23.352 |
| 1,3E-Pentadiene | | E7857 | 1 | 595 | 125 | 2.354 | 0.000 | 14.164 | 0.000 | 0.000 |
| Heptane | | E15342 | 700 | 687 | 159 | 2.551 | 11.607 | 0.000 | 0.000 | 23.352 |
| 1-Heptene | | E2908 | 1 | 726 | 188 | 2.665 | 18.393 | 65.796 | 580.147 | 149.653 |
| Propionaldehyde | 170 | E2800 | 1 | 753 | 213 | 2.753 | 0.000 | 0.241 | 0.000 | 0.000 |
| Octane | | E15343 | 800 | 787 | 244 | 2.897 | 8.973 | 0.000 | 61.638 | 6.529 |
| Acrolein | | | | 821 | 293 | 3.092 | 0.000 | 40.397 | 0.000 | 0.000 |
| 1-Octene | | E2806 | 823 | 826 | 303 | 3.134 | 8.527 | 0.000 | 298.479 | 205.146 |
| 1,3-Cyclohexadiene | | E7600 | 868 | 843 | 332 | 3.332 | 0.000 | 4.116 | 0.000 | 0.000 |
| 2-Methyltetrahydrofuran | | E5951 | 878 | 848 | 341 | 3.332 | 0.000 | 18.595 | 0.000 | 0.000 |
| C4 Aldehyde | 37.3 | E2877 | 876 | 854 | 352 | 3.332 | 0.000 | 19.021 | 0.000 | 3.766 |
| 2E-Octene | | E9866 | 854 | 855 | 354 | 3.345 | 2.188 | 0.000 | 0.000 | 0.000 |
| 2-Butanone | 50000 | | | 887 | 410 | 3.573 | 0.000 | 0.426 | 0.000 | 0.000 |
| Nonane | | E196 | 900 | 888 | 412 | 3.576 | 8.795 | 0.593 | 82.371 | 49.717 |
| 2-Methylbutyraldehyde | 0.9 | E2910 | 911 | 911 | 471 | 3.868 | 0.000 | 2.503 | 0.000 | 0.000 |
| Benzene | | E2818 | 949 | 926 | 523 | 4.018 | 0.000 | 34.465 | 0.000 | 0.000 |
| 1-Nonene | | E2803 | 946 | 927 | 525 | 4.037 | 18.103 | 0.000 | 0.000 | 0.000 |
| Isopropylcyclohexane | | E10041 | 985 | 959 | 631 | 4.466 | 1.027 | 0.000 | 0.000 | 0.000 |
| C5 Aldehyde | 76 | E850 | 985 | 966 | 655 | 4.567 | 0.000 | 45.218 | 159.326 | 169.490 |
| 1,8-Nonadiene | | E9955 | 988 | 974 | 681 | 4.67 | 2.009 | 0.000 | 0.000 | 0.000 |
| Decane | | E197 | 1000 | 987 | 724 | 4.842 | 2.121 | 0.000 | 25.216 | 41.682 |
| 1-Ethylcyclohexene | | | | 988 | 727 | 4.86 | 0.000 | 0.000 | 43.334 | 0.000 |
| I Diethyltetrahydrofuran | | E1436 | 1034 | 1009 | 820 | 5.246 | 0.000 | 12.199 | 30.446 | 62.272 |
| Cyclooctene | | E5247 | 1085 | 1020 | 877 | 5.47 | 20.067 | 0.000 | 0.000 | 0.000 |
| 1-Octine | | E10043 | 1023 | 1025 | 903 | 5.586 | 0.000 | 0.000 | 147.932 | 0.000 |
| 4E-Decene | | E9187 | 1031 | 1025 | 906 | 5.586 | 0.000 | 0.000 | 255.705 | 0.000 |
| 1-Decene | | | | 1025 | 906 | 5.586 | 0.000 | 0.000 | 0.000 | 188.573 |
| Toluene | | E2819 | 1043 | 1026 | 912 | 5.586 | 0.000 | 0.000 | 0.000 | 15.568 |
| Diethyltetrahydrofuran P.2 | | E9625 | 1052 | 1028 | 922 | 5.651 | 0.000 | 23.082 | 0.000 | 0.000 |
| 3-Isopropylcyclohexene | | E17990 | 1047 | 1045 | 1014 | 6.024 | 1.942 | 0.000 | 0.000 | 0.000 |
| Butylcyclohexane | | E4278 | 1 | 1057 | 1083 | 6.303 | 0.424 | 0.000 | 0.000 | 41.431 |
| 2-Hexanone | 400 | E739 | 1082 | 1070 | 1151 | 6.63 | 0.000 | 2.651 | 0.000 | 46.955 |
| C6 Aldehyde | 16 | E188 | 1094 | 1072 | 1162 | 6.629 | 7.098 | 107.158 | 506.36 | 529.311 |
| Undecane | | E198 | 110 | 1088 | 1249 | 6.984 | 2.589 | 0.000 | 0.000 | 0.000 |
| 1-Hexen-3-one | | E6968 | 1095 | 1090 | 1259 | 7.116 | 0.000 | 0.000 | 0.000 | 36.911 |
| Ethylbenzene | | E2813 | 1129 | 1116 | 1436 | 7.707 | 0.000 | 0.946 | 0.000 | 0.000 |
| 2E-Pentenal | 1500 | E1212 | 1129 | 1121 | 1474 | 7.898 | 0.000 | 2.651 | 0.000 | 0.000 |
| 5-Hexenal | | E1108 | 1134 | 1123 | 1494 | 7.987 | 0.000 | 3.337 | 0.000 | 0.000 |
| 1-Undecene | | E860 | 1141 | 1131 | 1549 | 8.203 | 42.232 | 16.185 | 393.73 | 479.594 |
| 3-Heptanone | | E1481 | 1163 | 1142 | 1634 | 8.549 | 0.000 | 5.080 | 0.000 | 0.000 |
| 2-Heptanone | 140 | E778 | 1185 | 1172 | 1860 | 9.468 | 0.000 | 12.644 | 0.000 | 0.000 |
| C7 Aldehyde | 5.8 | E189 | 1195 | 1175 | 1883 | 9.56 | 2.522 | 89.786 | 714.25 | 810.539 |
| Limonene | 162 | E259 | 1201 | 1185 | 1965 | 9.894 | 13.839 | 5.376 | 87.788 | 0.000 |
| Dodecane | | E199 | 1200 | 1188 | 1985 | 9.977 | 3.125 | 0.000 | 43.147 | 0.000 |
| 1-Hepten-3-one | | E1481 | 1196 | 1190 | 2001 | 10.039 | 0.000 | 5.061 | 39.224 | 78.342 |
| Furfural | 31 | E174 | 1452 | 1194 | 2030 | 10.173 | 0.000 | 0.000 | 0.000 | 25.361 |
| Prenyl formate | | E1334 | 1190 | 1194 | 2033 | 10.173 | 0.000 | 0.000 | 0.000 | 87.884 |
| Propylbenzene | | E2820 | 1204 | 1198 | 2060 | 10.173 | 0.000 | 0.000 | 0.000 | 17.828 |
| 2E-Hexenal | 27.2 | E1953 | 1215 | 1209 | 2158 | 10.68 | 0.000 | 7.546 | 69.110 | 73.320 |
| 3,4-Heptanedione | | | | 1216 | 2221 | 10.998 | 0.000 | 0.000 | 28.951 | 0.000 |
| 6-Dodecene | | E12203 | 1231 | 1221 | 2269 | 11.133 | 0.000 | 0.000 | 38.104 | 10.546 |
| 1-Dodecene | | E4226 | 1240 | 1231 | 2355 | 11.483 | 6.808 | 0.000 | 146.998 | 153.922 |
| 6-Heptenal | | E11087 | 1245 | 1233 | 2379 | 11.579 | 0.000 | 3.893 | 0.000 | 70.809 |
| 3-Octanone | 1000 | E223 | 1255 | 1243 | 2465 | 11.94 | 0.000 | 4.227 | 0.000 | 60.263 |
| 1,3E-Undecadiene | | E7640 | 1255 | 1245 | 2479 | 11.987 | 57.567 | 6.785 | 700.622 | 587.817 |
| Styrene | 22 | E5821 | 1248 | 1245 | 2487 | 12.014 | 0.000 | 2.614 | 9.339 | 12.806 |
| 2-Octanone | 211 | E257 | 1296 | 1273 | 2740 | 13.05 | 0.000 | 7.434 | 90.029 | 174.512 |
| C8 Aldehyde | 8 | E190 | 1297 | 1278 | 2779 | 13.204 | 0.000 | 19.522 | 311.367 | 470.052 |
| Tridecane | | E200 | 1300 | 1288 | 2875 | 13.602 | 3.348 | 0.000 | 17.744 | 0.000 |
| 1,3-Octenone | 0.01 | E3038 | 1296 | 1290 | 2894 | 13.668 | 0.000 | 15.369 | 28.578 | 137.601 |
| Butylbenzene | | E2839 | 1306 | 1300 | 2982 | 14.01 | 0.000 | 0.000 | 19.425 | 112.993 |
| 2E-Heptenal | 77 | E1480 | 1334 | 1313 | 3106 | 14.532 | 3.371 | 36.819 | 221.711 | 304.078 |
| 1-Pentyl-1,3- | | E11748 | 1347 | 1318 | 3153 | 14.726 | 11.875 | 0.000 | 29.512 | 0.000 |
| Cyclohexadiene | | | | | | | | | | |
| 6,5,2-Methylheptenone | 50 | E947 | 1334 | 1334 | 3260 | 15.162 | 0.000 | 1.798 | 0.000 | 0.000 |
| Trans-4-Heptenoic acid | | E21598 | 1322 | 1322 | 3272 | 15.212 | 0.000 | 2.688 | 30.072 | 0.000 |
| methyl ester | | | | | | | | | | |
| 1-Tridecene | | E10111 | 1343 | 1331 | 3282 | 15.254 | 4.710 | 0.000 | 77.328 | 77.840 |
| 7-Octenal | | E11081 | 1345 | 1335 | 3314 | 15.38 | 0.000 | 2.058 | 0.000 | 59.259 |
| 4-Methyl-3-cyclohexanone | | | | 1356 | 3522 | 16.227 | 0.000 | 0.000 | 0.000 | 78.091 |
| Allyl capronate | | E656 | 1372 | 1362 | 3577 | 16.458 | 0.000 | 0.000 | 0.000 | 93.910 |
| 2-Nonanone | 7700 | E1006 | 1399 | 1376 | 3716 | 17.021 | 0.000 | 2.633 | 0.000 | 0.000 |
| 2-Formyl-5-norbornene P.1 | | E1736 | 1393 | 1380 | 3751 | 17.209 | 0.000 | 1.372 | 0.000 | 0.000 |
| C9 Aldehyde | 18 | E191 | 1383 | 1381 | 3763 | 17.209 | 0.000 | 29.366 | 765.995 | 888.630 |
| Tetradecane | | E10930 | 1400 | 1388 | 3827 | 17.471 | 3.214 | 0.000 | 0.000 | 0.000 |
| 1,3E,5E-Undecatriene | | E2689 | 1391 | 1393 | 3876 | 17.619 | 5.826 | 6.155 | 11.954 | 7.282 |
| Pentylbenzene | | E2902 | 1423 | 1399 | 3932 | 17.893 | 5.134 | 0.000 | 99.555 | 152.667 |
| 2E-Octenal | 90 | E2560 | 1437 | 1420 | 4097 | 18.569 | 0.000 | 14.127 | 147.932 | 286.752 |
| 2-Formyl-5-norbornene | | E1737 | 1435 | 1429 | 4165 | 18.848 | 0.000 | 7.267 | 0.000 | 0.000 |
| Peak 2 | | | | | | | | | | |
| 2-Phenylpentane | | E2836 | 1 | 1430 | 4168 | 18.835 | 0.000 | 0.000 | 0.000 | 37.162 |
| 1-Tetradecene | | E20779 | 1443 | 1441 | 4251 | 19.196 | 10.246 | 2.596 | 0.000 | 166.979 |
| 2-Cyclohexyl-propanal | | E10384 | 1444 | 1441 | 4255 | 19.214 | 0.000 | 0.000 | 0.000 | 53.232 |
| 5Z-Tetradecene | | E8597 | 1443 | 1446 | 4289 | 19.349 | 0.000 | 0.000 | 123.463 | 0.000 |
| 1,3-Octenol | 1 | E2080 | 1446 | 1450 | 4325 | 19.499 | 0.000 | 1.780 | 15.503 | 43.440 |
| 1,13-Tetradecadiene | | E7674 | 1488 | 1482 | 4565 | 20.471 | 0.000 | 0.000 | 0.000 | 176.72 |
| Indene | | E269 | 1464 | 1483 | 4575 | 20.51 | 0.000 | 0.482 | 0.000 | 0.000 |
| 2-Decanone | 250 | E1132 | 1488 | 1501 | 4712 | 21.072 | 0.000 | 2.225 | 110.05 | 159.46 |
| 2E,4E-Heptadienal | 49 | E5236 | 1482 | 1502 | 4728 | 21.072 | 0.000 | 0.519 | 0.000 | 0.000 |
| C10 Aldehyde | 6 | E192 | 1502 | 1505 | 4762 | 21.27 | 0.000 | 1.409 | 96.006 | 160.93 |
| Pentadecane | | E15344 | 1500 | 1508 | 4795 | 21.41 | 8.348 | 1.187 | 97.127 | 0.000 |
| Hexylbenzene | | E1798 | 1515 | 1518 | 4916 | 21.899 | 1.116 | 0.000 | 0.000 | 35.656 |
| Benzaldehyde | 72 | E239 | 1530 | 1524 | 4984 | 22.188 | 0.000 | 0.000 | 0.000 | 47.206 |
| 1-Pentadecene | | E10539 | 1545 | 1528 | 5031 | 22.37 | 17.255 | 0.000 | 21.667 | 37.413 |
| 2E-Nonenal | 6 | E4839 | 1529 | 1534 | 5102 | 22.657 | 0.000 | 6.915 | 116.19 | 321.96 |
| 2-Octylfuran | | E4141 | 1518 | 1535 | 5116 | 22.657 | 0.000 | 1.724 | 43.894 | 0.000 |
| C8 Alcohol | 130 | E183 | 1550 | 1554 | 5349 | 23.663 | 0.000 | 1.594 | 0.000 | 85.373 |
| 3-Undecanone | | E8468 | 1565 | 1558 | 5396 | 23.849 | 0.000 | 0.000 | 15.129 | 0.000 |
| 2E,4E-Octadienal | | E2919 | 1574 | 1577 | 5619 | 24.76 | 0.000 | 0.426 | 0.000 | 40.175 |
| 2-Undecanone | 91 | E365 | 1608 | 1584 | 5700 | 25.084 | 0.000 | 0.612 | 50.805 | 94.663 |
| 1-Hexadecene | | E4227 | 1645 | 1601 | 5898 | 25.902 | 4.063 | 0.000 | 57.342 | 76.835 |
| 2Z-Decenal | | E5008 | 1606 | 1605 | 5934 | 26.041 | 0.000 | 0.000 | 33.434 | 100.49 |
| 2E-Decenal | 17 | E4567 | 1636 | 1623 | 6098 | 26.71 | 4.420 | 11.216 | 439.499 | 681.77 |
| Pentacosadiene | | | | 1658 | 6405 | 27.956 | 0.000 | 0.000 | 232.544 | 0.000 |
| 2E,4E-Nonadienal | 0.09 | E4545 | 1687 | 1682 | 6623 | 28.844 | 0.000 | 0.723 | 22.787 | 57.501 |
| Heptadecane | | E15346 | 1700 | 1686 | 6655 | 28.976 | 5.603 | 0.000 | 0.000 | 42.435 |
| 2Z-Undecenal | | E5009 | 1708 | 1701 | 6792 | 29.54 | 0.000 | 0.000 | 0.000 | 85.373 |
| 8Z-Heptadecene | | E10194 | 1715 | 1702 | 6800 | 29.585 | 62.523 | 2.410 | 314.542 | 215.44 |
| 1-Heptadecene | | E10543 | 1746 | 1705 | 6825 | 29.663 | 16.786 | 0.000 | 0.000 | 146.13 |
| 2E-Undecenal | 20 | E1761 | 1739 | 1730 | 7059 | 30.618 | 4.888 | 3.745 | 278.306 | 429.37 |
| 1-Undecen-3-ol | | | | 1736 | 7110 | 30.819 | 0.000 | 1.706 | 61.451 | 88.637 |
| 2E,4Z-Decadienal | | E7706 | 1761 | 1745 | 7194 | 31.166 | 0.000 | 0.000 | 21.667 | 60.514 |
| 2E,4E-Decadienal | 2.7 | E4546 | 1809 | 1786 | 7563 | 32.668 | 4.018 | 1.947 | 53.980 | 119.02 |
| 1-Octadecene | | E4229 | 1845 | 1796 | 7653 | 33.038 | 45.268 | 0.000 | 50.431 | 35.907 |
| Capronic acid | 3944 | | | 1825 | 7895 | 34.018 | 0.000 | 0.797 | 10.833 | 46.453 |
| 2E-Dodecenal | 14 | E1762 | 1844 | 1835 | 7982 | 34.373 | 0.000 | 0.000 | 20.359 | 46.453 |
| Nonadecane | | E15348 | 1900 | 1881 | 8358 | 35.898 | 0.737 | 0.000 | 0.000 | 0.000 |
| γ-Octalactone | 30 | | | 1887 | 8410 | 36.117 | 0.000 | 0.000 | 0.000 | 34.149 |
| 2E,4E-Undecadienal | 1 | E1750 | 1898 | 1893 | 8463 | 36.33 | 0.000 | 0.000 | 12.141 | 49.215 |
| C14 Aldehyde | 67 | E959 | 1904 | 1899 | 8514 | 36.538 | 0.000 | 0.000 | 10.647 | 35.907 |
| Neophytadiene | | E14689 | 1924 | 1904 | 8550 | 36.682 | 8.103 | 0.000 | 0.000 | 0.000 |
| Heptanoic acid | 640 | E4872 | 1947 | 1931 | 8767 | 37.562 | 0.000 | 2.929 | 52.673 | 92.655 |
| Hept-6-enoic acid | | | | 1994 | 9286 | 39.672 | 0.000 | 2.243 | 41.839 | 84.117 |
| Pentadecanal | 430 | E6200 | 2011 | 2003 | 9356 | 39.963 | 0.000 | 0.000 | 25.402 | 46.704 |
| Caprylic acid | 100 | E1420 | 2038 | 2035 | 9606 | 40.976 | 1.027 | 1.428 | 25.963 | 56.246 |
| Oct-7-enoic acid | | | | 2095 | 10074 | 42.88 | 0.000 | 0.000 | 20.173 | 55.743 |
| 1-Heneicosene | | E18556 | 2148 | 2102 | 10128 | 43.096 | 2.165 | 0.000 | 0.000 | 0.000 |
| Pelargonic acid | 3000 | | | 2139 | 10402 | 44.216 | 0.000 | 1.298 | 19.239 | 50.973 |
| 2-Decen-1,4-olide | | | | 2154 | 10512 | 44.69 | 0.000 | 0.000 | 0.000 | 39.924 |
| Non-8-enoic acid | | | | 2199 | 10845 | 46.019 | 0.000 | 0.000 | 16.250 | 43.942 |
| Ethyl palmitate | 2000 | | | 2228 | 11051 | 46.85 | 0.246 | 0.000 | 0.000 | 0.000 |
| 8Z-Heptadecenal | | E11071 | 2256 | 2234 | 11094 | 47.031 | 20.826 | 2.095 | 156.71 | 139.358 |
| Capric acid | 3500 | E2660 | 2253 | 2245 | 11173 | 47.353 | 56.541 | 26.103 | 259.44 | 255.114 |
| 8Z,11Z-Heptadecadienal | | | | 2281 | 11434 | 48.415 | 2.656 | 0.000 | 0.000 | 0.000 |
| Dec-4-enoic acid | | | | 2295 | 11533 | 48.82 | 0.000 | 0.000 | 0.000 | 32.140 |
| 9-Decenoic acid | | E5340 | 2341 | 2296 | 11534 | 48.818 | 2.723 | 2.447 | 22.040 | 24.356 |
| 3-Decenoic acid | | E14316 | 2365 | 2304 | 11592 | 49.054 | 0.000 | 0.000 | 8.966 | 0.000 |
| Benzoic acid | | E2515 | 2432 | 2394 | 12208 | 51.555 | 2.879 | 0.575 | 0.000 | 12.806 |
| 10-Undecylenic acid | | E5773 | 2436 | 2409 | 12305 | 51.957 | 0.000 | 0.000 | 7.845 | 20.088 |
| Methyl oleate | | E1635 | 2439 | 2414 | 12339 | 52.091 | 1.406 | 0.000 | 6.351 | 0.000 |
| Ethyl oleate | 867 | E2259 | 2481 | 2450 | 12575 | 53.048 | 3.237 | 0.000 | 13.448 | 0.000 |
| Lauric acid | 10000 | E3250 | 2473 | 2455 | 12609 | 53.188 | 5.848 | 0.649 | 0.000 | 0.000 |
| Myristic acid | 10000 | E4873 | 2711 | 2665 | 13943 | 58.618 | 19.621 | 0.000 | 10.460 | 0.000 |
| Palmitic acid | | E4875 | 2 | 2880 | 15193 | 63.704 | 57.612 | 11.235 | 82.371 | 79.346 |
| Stearic acid | 20000 | E4238 | 2 | | 16748 | 70.014 | 11.094 | 0.000 | 0.000 | 0.000 |
| Oleic acid | | E14320 | 2 | | 17039 | 71.213 | 140.090 | 28.718 | 290.821 | 389.450 |
| Linolic acid | | E13879 | 1 | | 17576 | 73.381 | 18.706 | 0.000 | 0.000 | 0.000 |
| | | | | | | | 817 | 904 | 9911 | 12141 |

### Example 2: Characterisation of the Reaction Product

0.5 g rapeseed oil was extracted in 2 g water with 100 ppm 2-nonanol as internal standard, 1 h by SBSE (Stir Bar Sorptive Extraction) (Twister) and analysed using GS/MS.

The sample relates to an aroma composition prepared according to the present invention in which the liquid oil phase was recycled four times.

The sample was analysed under the same MS/GC analysis conditions as described in Example 1.

The results of the gas chromatography are indicated in Table 5 below and compared to the results of the high oleic sunflower oil sample according to Example 1. Table 5 is merely an excerpt of the main ingredients of the flavour profile but does not comprise all ingredients of the flavour profile.

TABLE 5

| | | | | High oleic | |
|---|---|---|---|---|---|
| | | | | sunflower oil | Rapeseed oil |
| | | | | recycled 4 | recycled 4 |
| | | | | times | times |
| | Threshold | | | SBSE | SBSE |
| Name MI | [ppb] | Index L | Time | [ppm] | [ppm] |
| HEXEN, 2E- | | 1 | 2.327 | 114.498 | 0.000 |
| HEXEN, 1- | | 1 | 2.327 | 113.003 | 165.583 |
| HEPTEN, 1- | | 1 | 2.554 | 580.147 | 368.869 |
| OCTANE | | 800 | 2.758 | 61.638 | 177.710 |
| OCTENE, 1- | | 823 | 3.017 | 298.479 | 251.020 |
| CYCLOHEXADIEN, 1,3- | | 868 | 3.137 | 0.000 | 119.392 |
| NONANE | | 900 | 3.418 | 82.371 | 95.139 |
| ETHYLFURAN, 2- | | 943 | 3.594 | 0.000 | 0.000 |
| CYCLOHEXENE, 1- | | 900 | 3.601 | 0.000 | 34.065 |
| METHYL- | | | | | |
| NONENE, 1- | | 946 | 3.79 | 0.000 | 152.244 |
| BENZENE | | 949 | 3.79 | 0.000 | 102.745 |
| ALCOHOL | 13000 | 934 | 3.867 | 198.176 | 873.004 |
| ALDEHYDE C 5 | 76 | 985 | 4.531 | 159.326 | 0.000 |
| DECANE | | 1000 | 4.768 | 25.216 | 0.000 |
| ETHYLCYCLOHEXEN, 1- | | | 4.86 | 43.334 | 0.000 |
| DIETHYL | | 1034 | 5.202 | 30.446 | 0.000 |
| TETRAHYDROFURAN I | | | | | |
| CYCLOHEXADIENE, 1- | | 1013 | 5.226 | 0.000 | 12.898 |
| METHYL-1,4- | | | | | |
| TOLUENE | | 1043 | 5.429 | 0.000 | 96.021 |
| OCTIN, 1- | | 1023 | 5.586 | 147.932 | 0.000 |
| DECEN, 4E- | | 1031 | 5.586 | 255.705 | 0.000 |
| DECENE, 1- | | 1040 | 5.839 | 0.000 | 16.095 |
| DECENE, 1- | | 1040 | 6.037 | 0.000 | 113.659 |
| ISOAMYL FORMATE | | 1073 | 6.404 | 0.000 | 0.000 |
| ALDEHYDE C 6 | 16 | 1094 | 6.622 | 506.368 | 43.215 |
| ETHYLBENZENE | | 1129 | 7.436 | 0.000 | 55.011 |
| UNDECEN, 1- | | 1141 | 8.309 | 393.738 | 342.190 |
| ALDEHYDE C 7 | 5.8 | 1195 | 9.65 | 714.257 | 44.758 |
| BENZENE, PROPYL- | | 1204 | 9.897 | 0.000 | 60.743 |
| LIMONENE | 162 | 1201 | 9.914 | 87.788 | 30.096 |
| HEPTEN-3-ON, 1- | | 1196 | 10.053 | 39.224 | 0.000 |
| DODECANE | | 1200 | 10.135 | 43.147 | 0.000 |
| HEXENAL, 2E- | 27.2 | 1215 | 10.681 | 69.110 | 0.000 |
| HEPTANEDIONE, 3,4- | | | 10.998 | 28.951 | 0.000 |
| DODECENE, 6- | | 1231 | 11.133 | 38.104 | 68.129 |
| DODECENE, 1- | | 1240 | 11.674 | 146.998 | 69.232 |
| STYRENE | 22 | 1248 | 12.157 | 9.339 | 13.670 |
| UNDECADIENE, 1,3E- | | 1255 | 12.157 | 700.622 | 395.988 |
| OCTANONE, 2- | 211 | 1296 | 13.093 | 90.029 | 0.000 |
| ALDEHYDE C 8 | 8 | 1297 | 13.299 | 311.367 | 0.000 |
| OCTENONE, 1,3- | 0.01 | 1296 | 13.823 | 28.578 | 0.000 |
| TRIDECANE | | 1300 | 13.823 | 17.744 | 0.000 |
| CYCLOHEXADIENE, 1- | | 1347 | 14.01 | 29.512 | 109.580 |
| PENTYL-1,3- | | | | | |
| BENZENE, BUTYL- | | 1306 | 14.01 | 19.425 | 34.175 |
| HEPTENAL, 2E- | 77 | 1334 | 14.569 | 221.711 | 22.379 |
| HEPTENSAEUREMETHYLESTER, | | | 15.232 | 30.072 | 0.000 |
| TRANS-4- | | | | | |
| TRIDECENE, 1- | | 1343 | 15.476 | 77.328 | 0.000 |
| NONANONE, 2- | 7700 | | 16.659 | 0.000 | 0.000 |
| UNDECATRIENE, 1,3,5- | | 1378 | 17.197 | 0.000 | 149.708 |
| UNDECATRIEN, 1,3E,5E- | | 1391 | 17.392 | 11.954 | 0.000 |
| ALDEHYDE C 9 | 18 | 1383 | 17.392 | 765.995 | 0.000 |
| BENZENE, PENTYL- | | 1423 | 17.985 | 99.555 | 39.136 |
| OCTENAL, 2E- | 90 | 1437 | 18.641 | 147.932 | 0.000 |
| TETRADECENE, 5Z- | | 1443 | 19.349 | 123.463 | 62.287 |
| OCTENOL, 1,3- | 1 | 1446 | 19.528 | 15.503 | 0.000 |
| INDENE | | 1464 | 20.029 | 0.000 | 6.284 |
| DECANONE, 2- | 250 | 1488 | 21.149 | 110.015 | 0.000 |
| ALDEHYDE C10 | 6 | 1502 | 21.366 | 96.006 | 0.000 |
| BENZENE, HEXYL- | | 1515 | 21.377 | 0.000 | 10.804 |
| PENTADECANE | | 1500 | 21.56 | 97.127 | 69.232 |
| NONENAL, 2E- | 6 | 1529 | 22.412 | 116.179 | 0.000 |
| PENTADECENE, 1- | | 1545 | 22.567 | 21.667 | 94.808 |
| FURAN, 2-OCTYL- | | 1518 | 22.721 | 43.894 | 0.000 |
| UNDECANONE, 3- | | 1565 | 23.849 | 15.129 | 0.000 |
| UNDECANONE-2 | 91 | 1608 | 25.149 | 50.805 | 0.000 |
| DECENAL, 2Z- | | 1606 | 26.041 | 33.434 | 0.000 |
| DECENAL, 2E- | 17 | 1636 | 26.85 | 439.499 | 31.529 |
| HEXADECENE, 1- | | 1645 | 27.061 | 57.342 | 62.507 |
| HEPTADECANE | | 1700 | 28.522 | 0.000 | 0.000 |
| NONADIENAL, 2E,4E- | 0.09 | 1687 | 28.864 | 22.787 | 0.000 |
| HEPTADECENE, 1- | | 1746 | 29.258 | 0.000 | 70.775 |
| HEPTADECENE, 8Z- | | 1715 | 29.715 | 314.542 | 341.749 |
| UNDECENAL 2E- | 20 | 1739 | 30.727 | 278.306 | 0.000 |
| UNDECEN-3-OL, 1- | | 1747 | 30.866 | 61.451 | 0.000 |
| DECADIENAL, 2E,4Z | | 1761 | 31.166 | 21.667 | 0.000 |
| DECADIENAL, 2E,4E- | 2.7 | 1809 | 32.691 | 53.980 | 27.560 |
| OCTADECENE, 1- | | 1845 | 33.036 | 50.431 | 0.000 |
| CAPRONIC ACID | 3944 | 1840 | 34.023 | 10.833 | 11.245 |
| DODECENAL, 2E- | 14 | 1844 | 34.373 | 20.359 | 0.000 |
| UNDECADIENAL, 2E,4E- | 1 | 1898 | 36.33 | 12.141 | 0.000 |
| ALDEHYDE C 14 | 67 | 1904 | 36.538 | 10.647 | 0.000 |
| HEPTANOIC ACID | 640 | 1947 | 37.564 | 52.673 | 49.609 |
| PENTADECANAL | 430 | 2011 | 39.963 | 25.402 | 0.000 |
| CAPRYLIC ACID | 100 | 2038 | 40.971 | 25.963 | 31.750 |
| PELARGONIC ACID | 3000 | 2149 | 44.22 | 19.239 | 16.206 |
| HEPTADECENAL, 8Z- | | 2256 | 47.095 | 156.711 | 36.710 |
| CAPRIC ACID | 3500 | 2253 | 47.384 | 259.441 | 169.001 |
| DECENOIC ACID 9- | | 2341 | 48.814 | 22.040 | 26.017 |
| DECENOIC ACID-3 | | 2365 | 49.054 | 8.966 | 0.000 |
| 10-UNDECYLENIC ACID | | 2436 | 51.957 | 7.845 | 0.000 |
| METHYL OLEATE | | 2439 | 52.097 | 6.351 | 0.000 |
| ETHYL OLEATE | 867 | 2481 | 53.054 | 13.448 | 0.000 |
| MYRISTIC ACID | 10000 | 2711 | 58.599 | 10.460 | 0.000 |
| PALMITIC ACID | | 2 | 63.689 | 82.371 | 121.927 |
| STEARIC ACID | 20000 | | 68.895 | 0.000 | 30.427 |
| OLEIC ACID | | 2 | 71.226 | 290.821 | 288.503 |
| | | | | 17594 | 10191 |

As can be derived from Table 5, the grill-type flavour profile of the rapeseed oil is also characterised by a significant content of capric acid, oleic acid, 2E-decenal, and 1-dodecene, despite differences in the fatty acid composition of the starting material, and, thus, resulting in a grill-type flavour profile that is dominated by grill-type flavour notes characterised by extremely fatty/oily and/or smoky and/or roasted and/or burnt and/or animalic flavour notes.

### Example 3: Sensory Evaluation

A sample of an aroma composition according to the present invention as obtained in Example 1 (4 cycles) was subjected to a sensory evaluation.

For comparison, a sample of an aroma composition prepared according to WO 2019/141357 A1 as obtained in Example 1 was used.

The odours of the aroma composition (0.1% in water) and their intensities were evaluated and compared by an expert panel of 4 persons (flavorists) on a scale of 1 to 8. 30 ml of the test solution was presented in a 80 ml plastic cup for the sensory evaluation.

The flavour notes used as parameters were: fatty/oily, soapy, waxy, burnt, roasted, phenolic, smoky, animalic, green, and impact.

As can be seen from the spider diagram in FIG. 7, the aroma composition according to the present invention has a higher impact, and the fatty/oily and/or smoky and/or roasted and/or burnt and/or animalic flavour notes are considerably enhanced, whereas the waxy flavour notes are suppressed compared to the aroma composition according to the prior art WO 2019/141357.

1. A method for preparing an aroma composition having a grill-type flavour profile, comprising the following sequence of steps:
(a) providing a vegetable or animal oil or fat or a mixture thereof;
(b) transferring the product of step (a) to a reactor and heating the product to a temperature in the range of 310° C. to 400° C., and a pressure in the range of 2 to 6 bars, to obtain an oil stream;
(c) atomising the oil stream, thereby fragmenting the oil stream into a liquid oil phase and an aerosol comprising an aroma composition having a grill-type flavour profile, by an atomising device;
(d) transferring the aerosol containing the aroma to a second line and transferring the liquid oil phase to a third line;
(e) discharging the aerosol containing the aroma by collecting the aerosol or absorbing the aerosol on a solid carrier or in a liquid carrier; and
(f) optionally returning the liquid oil phase from step (d) to the reactor.

2. The method according to claim 1, wherein the product of step (a) is heated in step (b) to a temperature in the range of 360° C. to 370° C. and/or a pressure in the range of 3 to 4 bars, and/or for 10 to 30 seconds.

3. The method according to claim 1, wherein the method comprises two to five cycles.

4. The method according to claim 1, wherein the process is performed without purging air.

5. The method according to claim 1, wherein
the atomising step is performed by flash evaporation and/or by a Venturi nozzle.

6. The method according to claim 1, wherein step (c) further comprises injecting a fluid or gas adjacent to the nozzle exit or applying a vacuum at a pressure in the range of 200 to 800 mbar adjacent to the nozzle exit.

7. The method according to claim 1, wherein the vegetable or animal oil or fat of step (a) is selected from the group consisting of unsaturated, saturated or partially saturated palm oil, palm kernel oil, soybean oil, sunflower oil, peanut oil, olive oil, rapeseed oil, grapeseed oil, canola oil, corn oil, coconut oil, sesame oil, poppyseed oil, safflower oil, pumpkin seed oil, rice bran oil, almond oil, pecan oil, macadamia oil, cottonseed oil, linseed oil, pig fat (lard), beef fat (tallow), mutton fat (tallow), bacon dripping, chicken fat, turkey fat, butter and mixtures of two or more of these oil and/or fats.

8. An aroma composition obtainable using the method according to claim 1, optionally in combination with a solid or liquid carrier and/or other suitable food additives.

9. The aroma composition according to claim 8, comprising:
(a) at least one type(s) of linear or branched, saturated or unsaturated aliphatic C8 to C20 monocarboxylic acids;
(b) at least one type(s) of α,β-unsaturated C6 to C14 aldehydes; and
(c) at least one type(s) of α,β-unsaturated C6 to C14 alkenes.

10. The aroma composition according to claim 9, wherein:
component (a) is selected from the group consisting of capric acid and oleic acid; and/or
component (b) is selected from the group consisting of 2E-decenal, 2E-undecanal and 2E,4E-decadienal; and/or
component (c) is selected from the group consisting of 1-dodecene.

11. The aroma composition according to claim 10, wherein the components (a) and (b) and (c) are present in a weight ratio of 4.5 to 6.5:6.5 to 8.5:4.5 to 6.5.

12. The aroma composition according to claim 10, comprising the following components:
capric acid at ≥150 ppm, in particular ≥230 ppm;
oleic acid at ≥250 ppm, in particular ≥350 ppm;
2E-decenal at ≥30 ppm, in particular ≥400 ppm; and
1-dodecene at ≥50 ppm, in particular ≥120 ppm.

13. A method of providing or enhancing a grill-type flavour profile in a foodstuff, food supplement, or animal feed comprising applying or adding the aroma composition according to claim 8 to the foodstuff, food supplement or animal feed.

14. A foodstuff, food supplement or animal feed comprising the aroma composition according to claim 8.

15. Apparatus for producing an aroma composition having a grill-type flavour profile, with a reactor comprising:
(i) a reservoir for vegetable or animal oil or fat or a mixture thereof, a pump, and a heater adapted to heat the vegetable or animal oil or fat or mixture thereof to generate a heated oil stream;
(ii) an atomizing device adapted to atomise the heated oil stream in order to fragment the oil stream into a liquid oil phase and an aerosol comprising an aroma composition having a grill-type flavour profile;
(iii) optionally an inlet adapted to inject a fluid or gas adjacent to the exit of the atomizing device or to apply a vacuum adjacent to the exit of the atomizing device;
(iv) a second line adapted to discharge the aerosol containing the grill-type flavour;
(v) a third line adapted to return the liquid oil phase to the reactor;
(vi) a container adapted to collect the aerosol; and
(vii) a collection vessel adapted to collect the liquid oil phase.

16. The apparatus according to claim 15, wherein the heater is an induction heater.

17. The apparatus according to claim 15, wherein the atomizing device is a nozzle.

18. The method according to claim 1, wherein the atomising device is a nozzle.

19. The apparatus according to claim 15, wherein the nozzle is a Venturi nozzle.

20. The method according to claim 13, wherein the providing or enhancing a grill-type flavour profile comprises providing or enhancing a fatty/oily and/or smoky and/or roasted and/or burnt and/or animalic flavour and simultaneously suppressing and/or reducing a waxy flavour in the foodstuff, food supplement or animal feed.
